(19) United States
(12) Patent Application Publication
(10) Pub. No.: US 2009/0037412 A1
(43) Pub. Date: Feb. 5, 2009

(54) QUALITATIVE SEARCH ENGINE BASED ON FACTORS OF CONSUMER TRUST SPECIFICATION

(76) Inventors: Kristina Butvydas Bard, Philadelphia, PA (US); Norma Ferrara, Ridley Park, PA (US)

Correspondence Address: BLANK ROME LLP, ONE LOGAN SQUARE, PHILADELPHIA, PA, 19103, US

(21) Appl. No.: 12/166,987

(22) Filed: Jul. 2, 2008

Related U.S. Application Data
(60) Provisional application No. 60/947,569, filed on Jul. 2, 2007.

(51) Int. Cl. G06F 7/06; G06F 17/30

(52) U.S. Cl. 707/5; 707/E17.108

(57) ABSTRACT

A method of providing a search engine for use on global computer networks which identifies and merges categories of information that reflect, influence and imitate intelligent choice by concurrently searching one or more of eight factors of consumer trust: books, experts, news and articles, associations, celebrities and pro choice, awards, web information and blogs and people's choice. The results from the search of these selected consumer trust factors are then combined to generate a final report.

### RELATED APPLICATION

This application claims benefit of U.S. Provisional Application Ser. No. 60/947,569, filed Jul. 2, 2007, entitled “Qualitative Search Engine Based on Factors of Consumer Trust Specification,” which is incorporated herein by reference.

### FIELD OF THE INVENTION

The present invention generally relates to the field of search engines, and particularly to a search engine based on voices of authority.

### BACKGROUND OF THE INVENTION

In the late 19th century, Melvin Dewey introduced a universal classification system based on a directory-like structure to identify books by their subject using numeric codes.

In 1985, Digital Equipment Corp. was the first company to establish a dot-com dec.com.

In the late 1960's, Gerard Salton developed SMART—Salton's Magical Automatic Retriever of Text—what some consider to be the first digital search engine, introducing seminal concepts commonly used in searches today, including concept identification based on statistical weighting, and relevance algorithms based on feedback from queries. Salton's work sparked a renaissance in the Information Retrieval field and inspired an annual conference on digital information retrieval known as the Text Retrieval Conference.

By the 1990's, academics and technologists were using the Internet to store papers, technical specs, and other kinds of documents on machines that were publicly accessible. Unless one had the exact machine address and file name, however, it was nearly impossible to find those archives.

In 1990, McGill University student Alan Emtage developed “Archie” to scour Internet based archives and build an index of each file. Using file transfer protocol (FTP), Archie users could query via a keyword in a file title, receive a list of places where a matching file might be found, and then connect to that machine.

In 1993, University of Nevada students created Veronica, and by substituting Gopher, (a more fully featured Internet file-sharing standard) for FTP, they enabled users to connect directly to the document queried as opposed to just the machine on which the document resided. From 1993 to 1996, the web grew from 130 sites to more than 600,000.

Massachusetts Institute of Technology researcher Matthew Gray created Wanderer to automatically create an index of sites. Many Webmasters felt that the Wanderer used too many processing and bandwidth cycles as it indexed sites' contents, so Gray set his crawler on a breadth algorithm to span many sites before drilling down—a more efficient process that is still used today.

In April 1994, University of Washington researcher Brian Pinkerton put his extracurricular project WebCrawler, the first search engine to index the full text of Web documents, online; by November, it recorded its one-millionth query. In June 1995, WebCrawler was sold to AOL for $1 million; in the late 1990's it was sold to Excite for $4.3 million.

In May 1994, Carnegie Mellon University's Dr. Michael Maudlin created Lycos, using more sophisticated algorithms to determine the meaning of a page and answer queries, becoming the first major engine to use links to a Web site as the basis of relevance—the underlying basis for Google's current success. It also introduced web page summaries in search results, rather than a simple list of links. For a short period in 1999, Lycos was the most popular online destination in the world. In May 2000, at the height of the bubble, Lycos was sold to Spanish telecom giant Terra for $12.5 billion; four years later, Terra sold Lycos to a South Korean company for about $100 million.

In the fall of 1994, Stanford PhD candidates Jerry Yang and David Filo debuted Jerry and David's Guide to the World Wide Web, the first iteration of what would later become Yahoo. Yang and Filo adopted a directory approach to navigation—sorting links into categories and subcategories. By the end of 1994, the site had thousands of links and traffic was doubling. In 1995, the site was re-named Yahoo, as an acronym for Yet Another Hierarchical Officious Oracle. The company went on to pioneer some of the Web's earliest social mores, including links to competitor's sites, and “what's hot” listings, and were among the first to realize the value of and track users' click streams.

In October 1994, HotWired, the web content portal of Wired magazine, went live, with advertising; a new approach to revenue borrowed from its print cousin.

In the fall of 1995, six Stanford University alumni debuted Excite as the first search engine to transcend classic keyword-based searching with technology that grouped Web pages by their underlying concepts, using statistical analysis of word relationships on the page. It also was one of the first services to allow users to create custom Web pages, and offer free e-mail. Excite was sold to @Home, then to Interactive Search Holdings, and ultimately in 2002, to Ask Jeeves.

In December 1995, Digital Equipment Corp. (DEC) gave the public access to altavista.digital.com, the closest thing to a complete index that the young Web had ever seen, with more than 16 billion documents and billions of words. DEC had recently come out with super fast Alpha processor and was looking for way to prove its might and the company's hardware dominance. Up to that point, search engines used single crawlers, but now, using the Alpha's 64-bit memory capability, DEC researcher Louis Monier was able to set a thousand crawlers loose at once, an unprecedented feat.

By 1996, AltaVista was arguably the best and most loved brand on the web. By 1997, it was the leader in a three way heat with Yahoo (AltaVista actually provides Yahoo's organic search results) and AOL, serving more than 25 million queries a day and on track to make $50 million in sponsorship revenues. In 1998, choosing hardware over search as its core business, AltaVista's parent DEC sold the search engine to Compaq for $9.6 billion: Compaq went on an acquisition spree, and unsuccessfully attempted an IPO, then sold to CMGI for $2.3 billion; with the dotcom bubble burst, CMGI's IPO also faltered and they sold AltaVista to Overtures Services, Inc. in 2003 for $140 million, which was then sold to Yahoo.

In 1995, while AltaVista was running its beta crawler and the Web consisted of only 10 billion documents, Stanford University graduate student Larry Page conceived of BackRub, a process to count and qualify back links on the Web, based on the concepts of Eugene Garfield, the father of citation analysis: a given paper's importance can be ascertained by noting how many other papers link to that paper through citation. Page enrolled fellow student Sergey Brin to collaborate and together they created an algorithm to take into account both the number of links into a particular site, and the number of links into each of the linking sites, roughly mirroring the Garfield's theories on academic citation counting. They found BackRub's results more relevant than AltaVista and Excite.

Sergey and Brin released the first version of Google on the Stanford Web site in August 1996. IBM researcher Jon Kleinberg, now a professor at Cornell, drafted “Authoritative Sources,” outlining a hubs-and-authorities approach to ranking the Web, now considered the second most famous approach to search after PageRank.

In 1998, Page and Brin published “The Anatomy of a Large-Scale Hypertextual Web Search Engine,” to become the most widely cited search-related publication in the world. By late 1998, Google served more than 10,000 queries a day. The partners raised $100,000 from Andy Becholsheim, incorporated, and rented friend Sarah Wojcicki's garage as an office for themselves and their one employee. Within the year, the partners raised another million dollars.

Also in 1998, Tim Berners-Lee, often considered the father of the web, published “Semantic Web Road Map,” outlining a universal and relatively simple approach to structuring metadata so that the Web becomes more intelligent.

In June 1998, Bill Gross received a lukewarm reception for the concept of paid search at the TED (Technology, Entertainment and Design) conference, but went on to successfully launch GoTo.com four months later, starting with 15 advertisers and growing to 8,000 in a little over a year. Gross introduced two revolutionary ideas: advertisers paid for a visitor only when a visitor clicked through an ad and onto the advertiser' sites; and the cost was only one cent per click. GoTo.com operated as both a destination and a syndication business until September 2001, changing its name to Overture, and focusing only on advertising.

At the start of 1999, Google staff numbered ten, occupied a real office, and raised $25 million in venture capital. By 2000, the company grew to 39 staff, all engineers, by the end of 2000; there were nearly 150 employees, and by 2001, they were over 200. The company lacked a viable plan for making money until early 2001.

Google adopted AdWords in 2000, and its own pay-per-click model in early 2002, as well as Froogle, an e-commerce search engine. In 2003, Google acquired Blogger weblog hosting company, and rolled out AdSense, allowing third party publishers to access Google's network of advertisers on a self-serve basis, placing contextually relevant ads next to content, much as AdWords did for Google's own site.

Jimmy Wales launched Wikipedia in 2001, using the wiki (Hawaiian word meaning quick), a system developed in 1995 by computer programmer Ward Cunningham as a fast way to build public knowledge bases. Wikipedia went on to become the world's largest encyclopedia, and in October 2004, Wales funded a for-profit company called Wikia using Wikipedia's best volunteer editors to build moneymaking websites, with advertising powered by Google's AdSense.

In 2003, IBM introduced WebFountain as a platform by which large corporate clients connect, query and develop applications. Through metadata tagging and classifying pages across numerous semantic categories, WebFountain basically restructured the Web, making complex, specific queries possible. WebFountain's better known clients are Semagix and Factiva, the Dow Jones news information search engine. WebFountain was the combined effort of 300 IBM scientists, who have collected more than 100 patents on the research since it began in the late 1990s.

A9 debuted in the spring of 2004, employing Google's index of web sites, and layering on top a robust interface as well as integrating Amazon's Search Inside the Book feature. A9 was the first search engine to employ the concept of search history tracking personal clickstreams.

In the fall of 2004, Bill Gross introduced SNAP, a new breed of search engine that ranked sites by factors such as how many times they have been clicked on by prior searchers, taking pay-per-click one better: advertisers could sign up to pay only when a customer converted, i.e., when the customer actually bought a product or performed a specific action deemed valuable by the advertiser, like giving up an e-mail address or registering for more information. In the fall of 2006, SNAP raised $16 million to develop further its ad model and to develop ways to present search results in a more compelling way.

Google went public in 2004. Its core defensible asset was considered to be distributed computing, a massively parallel formation of cheap processing and storage, individual parts none of which depended entirely on the others; the company did develop its own operating system on top of its servers, customizing and patenting its approach to designing, cooling, and stacking its components. The other major asset—the PageRank patent—is owned by Stanford University, but licensed exclusively to Google until 2011.

In late 2004 and 2005, a new kind of tagging scheme arose, based on the wisdom of the crowds. Small start-up companies like Flickr (later sold to Yahoo), Technorati (a weblog search engine) and deLicio.us (a link-sharing site) begin to give users the ability to tag anything they saw, and share those tags with others. The wisdom of crowds theory was that ultimately a kind of relevance for any given item emerges. Early bloggers dub this approach as “folksonomies” —folk+taxonomy.

Hakia was founded in 2004, and debut its full-capacity search engine in 2007. Another step in the semantic web, Hakia promised to offer “meaning-based” search as opposed to citation frequency.

In 2004, Global Spec, an engineering-specific search engine that got its start in the mid-1990's as an online catalog, developed Engineering Web, one of the first vertical domain specific search engines. Human editors identified 100,000 or so very specific engineering sites, built a crawler to index those sites, then surfaced invisible Web databases not found in mainstream search engines, like patent and standards sites that are usually walled off.

By 2005, all the major search engines had launched desktop search tools which indexed one's hard drive and served up the results much as one sees Web results.

In 2005, Scott Jones launched ChaCha using human guides who logged on from their homes and answered queries in real time via instant-messaging.

Currently, deep databases of knowledge, like the University of California's library system or the LexisNexis news and legal citation service remain walled off from search for commercial or technological reasons. Massive archiving projects like Google Print, the Internet Archive and Amazon's Search Inside the Book have set out to gather the sum total of all humankind's information. A study released in early 2007 by IDC Research Inc. notes that last year's digital data were 3 million times the information in all the books ever written, or 161 Exabyte of digital data. (See John Battelle's “The Search,” John Wiley & Sons, 2006).

### SUMMARY OF THE INVENTION

A method of providing a search engine for use on global computer networks which identifies and merges categories of information that reflect, influence and imitate intelligent choice. The method comprises the steps of: concurrently searching a product, service or topic using one or more of psychosocial indicators of books, experts, news and articles, associations, celebrities and pro choices, awards, global computer networks information and blogs, and people's choice to generate respective search results for each of said indicators, arranging said search results for each of said indicators from most credible to least credible, and combining the search results of the categories to form a report that ranks the searched product, service or topic from most preferred to least preferred.

In one aspect of the present invention, said step of concurrently searching comprises four layers for each of said indicators, said layers comprises activating building blocks, precursors and sources as a first layer to generate first layer results, inputting said first layer results into a second layer comprising semantic and citation analysis searching to form second layer results, inputting said second layer results into a third layer that comprises general filtering based on the respective category to form third layer results, and inputting said third layer results into a fourth layer that comprises special filtering based on the respective category to form fourth layer results.

The present invention method further comprises the step of generating a report for a respective indicator.

In another aspect of the present invention, said step of combining said search results comprises applying weights to the search results from each of said indicators.

In one embodiment of the present invention, said special filtering for said indicator of books comprises searching best-selling statistics, date of publication, book reviews, volume in print/sales, merge of top publishers and supplier data.

In one embodiment of the present invention, said special filtering for said indicator of experts comprises various news sources on specific products, services or topics written by known experts.

In one embodiment of the present invention, said special filtering for said indicator of news comprises qualitative media indicator data from current demographics, audience education, circulation which determine believability.

In one embodiment of the present invention, said special filtering for said indicator of associations comprises qualitative association data, longevity, journals, membership demographics and industry standard development.

In one embodiment of the present invention, said special filtering for said indicator of celebrities and pro choice comprises qualitative celebrity and pro indicator data including industry rank a number of pros using the product or service.

In one embodiment of the present invention, said special filtering for said indicator of awards comprises manufacturer data, association sites and ranking of said association sites according to their qualitative data.

In one embodiment of the present invention, said special filtering for said indicator of global computer networks information and blogs comprises qualitative indicators of sources' believability including paid versus unpaid, longevity, volume on subject, and retailer versus manufacturer consumer data.

In one embodiment of the present invention, said special filtering for said indicator of people's choice comprises real-time and archived data and polled summaries with statistical ranking for quality, design and cost.

The present invention also provides a system of a search engine for use on global computer networks which identifies and merges categories of information that reflect, influence and imitate intelligent choice, said system comprising a web server that performs the steps of concurrently searching a product, service or topic using one or more of psychosocial indicators of books, experts, news and articles, associations, celebrities and pro choices, awards, global computer networks information and blogs, and people's choice to generate respective search results for each of said indicators, arranging said search results for each of said indicators from most credible to least credible, and combining said search results of said indicators to form a report that ranks the searched product, service or topic from most preferred to least preferred.

In one aspect of the present invention, said step of concurrently searching comprises four layers for each of said indicators, said layers comprises activating building blocks, precursors and sources as a first layer to generate first layer results, inputting said first layer results into a second layer comprising semantic and citation analysis searching to form second layer results, inputting said second layer results into a third layer that comprises general filtering based on the respective category to form third layer results, and inputting said third layer results into a fourth layer that comprises special filtering based on the respective category to form fourth layer results.

The present invention web server further performs the step of generating a report for a respective indicator.

In one embodiment of the invention, said step of combining said search results comprises applying weights to the search results from each of said indicators.

In one embodiment of the invention, said special filtering for said indicator of books comprises searching best-selling statistics, date of publication, book reviews, volume in print/sales, merge of top publishers and supplier data.

In one embodiment of the invention, said special filtering for said indicator of experts comprises various news sources on specific products, services or topics written by known experts.

In one embodiment of the invention, said special filtering for said indicator of news comprises qualitative media indicator data from current demographics, audience education, circulation which determine believability.

In one embodiment of the invention, said special filtering for said indicator of associations comprises qualitative association data, longevity, journals, membership demographics and industry standard development.

In one embodiment of the invention, said special filtering for said indicator of celebrities and pro choice comprise qualitative celebrity and proc indicator data including industry rank a number of pros using the product or service.

In one embodiment of the invention, said special filtering for said indicator of awards comprises manufacturer data, association sites and ranking of said association sites according to their qualitative data.

In one embodiment of the invention, said special filtering for said indicator of global computer networks information and blogs comprises qualitative indicators of sources' believability including paid versus unpaid, longevity, volume on subject, and retailer versus manufacturer consumer data.

In one embodiment of the invention, said special filtering for said indicator of people's choice comprises real-time and archived data and polled summaries with statistical ranking for quality, design and cost.

### BRIEF DESCRIPTION OF THE DRAWINGS

The invention will be described in conjunction with the following drawings in which like reference numerals designate like elements and wherein:

FIG. 1 is a flow diagram of the method of the present invention known as psychosocial indicators for qualitative search engine ecommerce (PIQSEE 20);

FIG. 2 is a detailed flow diagram of the “books” psychosocial indicator path of the present invention;

FIG. 3 is a detailed flow diagram of the “PIQSEE 20 mavens” psychosocial indicator path of the present invention;

FIG. 4 is a detailed flow diagram of the “news” psychosocial indicator path of the present invention;

FIG. 5 is a detailed flow diagram of the “associations” psychosocial indicator path of the present invention;

FIG. 6 is a detailed flow diagram of the “celebrities and pro choice” psychosocial indicator path of the present invention;

FIG. 7 is a detailed flow diagram of the “awards” psychosocial indicator path of the present invention;

FIG. 8 is a detailed flow diagram of the “web info and blogs” psychosocial indicator path of the present invention;

FIG. 9 is a detailed flow diagram of the “people's choice” psychosocial indicator path of the present invention;

FIG. 10 is an exemplary display screen which provides the user with the ability to generate the PIQSEE 20 final or “simple” report or to permit the user to select the psychosocial indicator(s) to be searched and generate the individual psychosocial indicator reports and using a search on a tennis racquet by way of example only;

FIGS. 11A-11B depict an exemplary display screen of a PIQSEE 20 final or “simple” report for an exemplary search on the best tennis racquet, by way of example only;

FIG. 12 is an exemplary display screen showing how a user may select the psychosocial indicator “celebrity & pro choice” for searching and reporting again using a search on the best tennis racquet by way of example only;

FIGS. 13A-13B depict an exemplary display screen for the celebrity & pro choice report selected in FIG. 12;

FIG. 14 is an exemplary display screen showing how a user may select the psychosocial indicator “people's choice” for searching and reporting again using a search on the best tennis racquet by way of example only;

FIGS. 15A-15B depicts an exemplary display screen for the people's choice report selected in FIG. 14;

FIG. 16 is an exemplary display screen showing how a user may select the psychosocial indicator “news & articles” for searching and reporting again using a search on the best tennis racquet by way of example only;

FIG. 17 depicts an exemplary display screen for the news & articles report selected in FIG. 16;

FIGS. 18A-18B depict an exemplary display screen when the user selects the “More Information” box from the PIQSEE 20 final report of FIG. 11A for the “Prince 03” tennis racquet;

FIG. 19 is a schematic diagram of an exemplary computing environment; and

FIG. 20 is a schematic diagram of an exemplary network environment.

### DETAILED DESCRIPTION

### The Present Invention

PIQSEE 20 is the acronym for Psychosocial Indicators for Qualitative Search Engine Ecommerce. PIQSEE 20 is the first search engine that identifies and merges categories of information that reflect, influence and hence imitate intelligent choice. The singularity of the concept is best understood in relation to the web developments that have occurred thus far. Web 1.0, as described by John Borland in “A Smarter Web,” Technology Review April 2007”, refers to the first generation of the commercial Internet, dominated by static postings of information, with content that was only marginally interactive. Web 2.0 added a new layer of interactivity, characterized by features such as tagging, social networks, and user-created taxonomies of content called “folksonomies.” The quantity of information increased exponentially, as did the vehicles for gathering and exchanging it. Web 3.0, as described by John Markoff in The New York Times November 2006, is a set of technologies that offer efficient new ways to help computers organize and draw conclusions from online data. The emphasis is on more readily accessing vast Web information, in effect giving computers the ability to “understand” semantic relationships and the “intelligence” to make connections and selections.

These stages in web history have involved the development of the technology to collect information, to include and merge user-generated information, and to retrieve that information through words and word groups. The qualitative selection of information from the web has been limited thus far to advances that are either word-based or people-based.

Word-based qualitative semantic web advances include: combining word groups and data sources to create more relevant meaning as in the work done by WebFountain, Factiva, Hakia and Zepheira creating a hierarchy of words using one main criteria of citation analysis (a given paper's importance can be ascertained by noting how many other papers link to that paper through citation) as exemplified by Google; and categorizing word groups and information, as has been done by sites such as Google and Yahoo on their advanced search pages.

People-based qualitative connectivity web advances include: combining user input, represented by such sites as Flickr, DeLicio.us, Wikipedia, and Opine; combining information from a select, closed group of users such as the news site Huffington Post or the shopping site ConsumerSearch where only editors' input is solicited and aggregated; accessing human-assisted real-time search, such as ChaCha; connecting information from other people, such as Amazon's “other people who bought this also bought,” or Yahoo's “here's what other human beings find useful related to your search”; and providing forums for individual opinion via blog and blog searches.

These word-based and people-based advances have provided useful, albeit limited, building blocks. While moving in the direction of achieving greater relevance of information, the result of a query is still quantitative, not qualitative. It may take only seconds for a search engine to post a result to a query, but it can take many minutes or hours to weed through all the information.

Google, as the largest and most prevalent search engine today, is based on one primary criteria defining quality of information, and that, citation analysis, is from the academic world.

The logic is that the more a paper (web site) is mentioned by other papers (web sites), it becomes more important. Pure volume of mentions does build some sense of importance, but even in academia, it is the quality of each of these mentions that makes a difference in the perception, credulity and real importance. Different mentions have different impact. One medical journal is considered more prestigious than another. It is not just about how many people are talking about you, but who is talking about you, and what they are saying.

No search engine has yet investigated the nature of perception, which is fundamental to understanding the definition of quality: On what basis does a human being make a choice between two things, positioning one thing above another? What factors influence a human being into believing that one thing is better than another? What types of information directly correlate to and impact perception?

It is Applicants' belief that the reason that these issues were not yet addressed is because all the work done in the area thus far has been done solely from the scientific, engineering perspective.

This scientific approach, which is quantitative by nature, is, not surprisingly, yielding quantitative results. In order to yield qualitative results, it is Applicants' approach that one needs to bring qualitative thinking to the equation, via the inclusion of consumer psychology and practical experience, i.e., the study of understanding people's wants and actions taken to fulfill them.

The roots of consumer psychology date back to World War II, and the Society for Consumer Psychology was formed in 1961 with primarily psychologists as members, growing to include marketers, advertisers, sociologists and the emerging field of neuromarketers.

Psychologists have indeed proven that unconscious as well as conscious influences in decision-making exist, but (per Stanford University scholar Itamar Simonson) literature does not yet offer totally clear definitions of these influences. Neuroscientists have identified the actual area of the brain, the medial prefrontal cortex, which is activated upon positive identification with a product, but (per neurologist Richard Restak) despite this remarkable progress in understanding the brain's anatomy and biochemistry, brain science has not advanced far enough yet to give marketers any persuasive powers, and the organ is far too complex an array of interconnected circuits to be that easily manipulated.

Consumer behaviorists, most notably John Howard and Jagdish Sheth in their “Theory of Buyer Behavior,” offer one of the best known models explaining the interactions involved in buyer decision making processes. Consumers receive “inputs” that are: significative (real physical aspects of the product); symbolic (ideas suggested by the supplier); or social (images about the product created by social groups). The consumer goes through “constructs” to decide upon a course of action, being either: perceptual (concerned with obtaining and handling information about the product) or learning (concerned with leading to the decision itself). The final “output” is the consumer's ultimate action.

Sociologists have identified patterns by which ideas and products have been adopted, notably through Everett Rogers seminal 1962 book “Diffusion of Innovation,” and more recently via social marketers like Seth Godin and Bzz Agent, journalist Malcolm Gladwell's “Tipping Point,” and marketing researchers Ed Kelly and Jon Berry's “The Influentials.” This area provides the closest relevant data regarding practical consumer decision-making, by (a) identifying that influencers go to multiple sources to gather information in order to make a decision; and (b) tracking four of the areas that Americans use as information sources: advertising, editorial, internet and people. No one has delineated these information sources beyond this rudimentary classification.

Stanford's Itamar Simonson further explains, “Choices are determined primarily by conscious, willful information processing of pertinent, task-relevant inputs, such as various interpretations of the options' attributes and their fit with the person's perceived preferences . . . choices naturally focus on options, and people tend to believe that options need to be evaluated in some fashion before a choice is made.”

PIQSEE 20 is the first search engine to take a qualitative approach, applying principles of consumer psychology to the analysis of information for consumer products.

The principles of basic information exchange can help clarify the PIQSEE 20 concept.

The basic communication model is: Speaker & message—vehicle that conveys message—recipient. In other words, a person wants to communicate something and they have to choose what vehicle they will use to convey their message, or how they are going to communicate it.

The basic consumer communication model is: Manufacturer & product—vehicle that conveys product information—consumer. In other words, someone has made something that someone else can use, and they, the manufacturer or creator, have to choose a vehicle to explain their product to someone else, deciding how they will tell people about the utility and value of what they made.

PIQSEE 20 presents the concept that vehicles that convey messages in communication, and vehicles that convey product information have inherent believability. This belief is based on the quality of the source information, not citation, or the number of times it is repeated. As noted earlier, it is not just how many people are talking about someone, but who, and what they are saying.

Through years of experience in the area of marketing and consumer psychology in selecting vehicles that convey product information, we have built a body of empirical, experience-based evidence that forms the PIQSEE 20 concept.

When a manufacturer is trying to position their product as a premiere brand in the eyes of the consumer, and they have limited resources, they focus on the most important communication vehicles that build prestige. From the other end of the communication model, when a consumer is trying to identify the best product in a given category, they go to certain key information sources to get the information they believe and trust. These avenues are based on historic behavior patterns that are for the most part are unconscious. Most people don't think about the process by which they make a decision to buy one thing over another; they just go find out information to satisfy themselves that they are making a good choice and then make a purchase.

There are varying amounts of information that different people want, but the most frequently consulted avenues remain constant. These voices of authority are trusted because each has their own hierarchy and method of opinion formation that operates independent of the manufacturer, as a filter for the manufacturer's information, contributing to its believability.

PIQSEE 20 has identified predominant information vehicles with high believability and calls them the key psychosocial indicators of qualitative information:
News
Books
Associations
People's Choice
Web information sites and blogs
Celebrity/professional choice
Mavens
Awards

This information currently exists on the Web, but it exists in isolated categories independent of each other and as such has fragmented meaning. The whole, however, is greater than the sum of the parts. PIQSEE 20 ranks items within the psychosocial indicator categories, and merges the categories. As such, PIQSEE 20 imitates the human decision-making process, and brings another element of meaning and intelligence to the web.

As Tim Berners-Lee, father of the Web, noted in Scientific American May/2001, “The real power of the Web will be realized when people create many programs that collect Web content from diverse sources, process the information, and exchange the results with other programs . . . . If an engine of the future combines a reasoning engine with a search engine, it may be able to get the best of both worlds . . . . It will be able to reach out to indexes which contain very complete lists of all occurrences of a given term, and then use logic to weed out all but those which can be of use in solving the given problem.”

PIQSEE 20, by using and combining consumer trust factors or psychosocial indicators, brings an element of reasoning that is a step above and different than what is currently available. PIQSEE 20 identifies at least 8 categories or psychosocial indicators (or voices of authority) that build consumer trust. When consumers want to purchase something, they turn to one of these 8 categories as a source of information. PIQSEE 20 is essentially creating 8 vertical search engines, one for each voice of authority or psychosocial indicator. PIQSEE 20 gathers all these sources in one place and also merges them, making them available for the two basic types of buyers: the “just tell me the best” type, and the “I want to read all the backup information” type. PIQSEE 20 is dissecting the consumer decision-making process and, by breaking it into discreet steps, is able to apply elements of human intelligence to the search process and thereby mimic intelligent human choice.

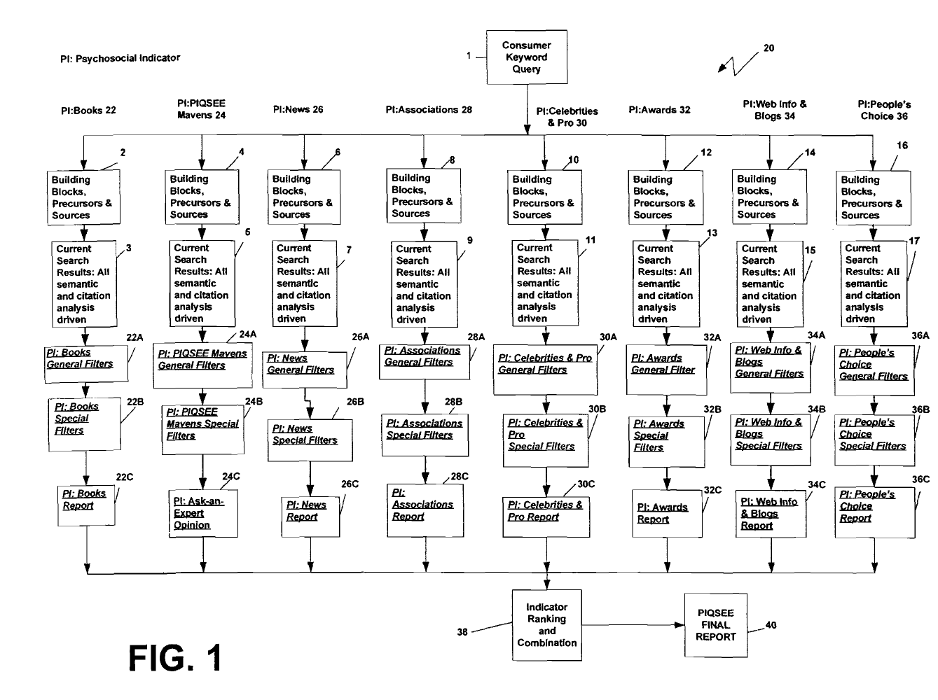

As shown most clearly in FIG. 1, the present invention (“PIQSEE”) 20 comprises concurrent search paths based on eight consumer trust factors, also referred to as psychosocial indicators (PIs), namely, books 22, PIQSEE mavens 24, news (also referred to as “news & articles”) 26, associations 28, celebrities and pro choice 30, awards 32, web info & blogs 34 and people's choice 36. The inventors of the present invention 20 have determined that these eight psychosocial indicators are what consumers trust and rely on when making decisions about selecting or purchasing items or retaining services. Consumers want to know, for example, what the experts or celebrities or professionals (who the consumers trust) think or believe about the products or services that they, i.e., the consumers, want to purchase or retain. Until now, and to the best of Applicants' knowledge, there is no search mechanism that utilizes these eight consumer trust factors and which then identifies, aggregates/merges and ranks the filtered search results of these eight factors into a single comprehensive report. It should be further noted that the number of such consumer trust factors or PIs may increase and are not limited to the eight consumer trust factors.

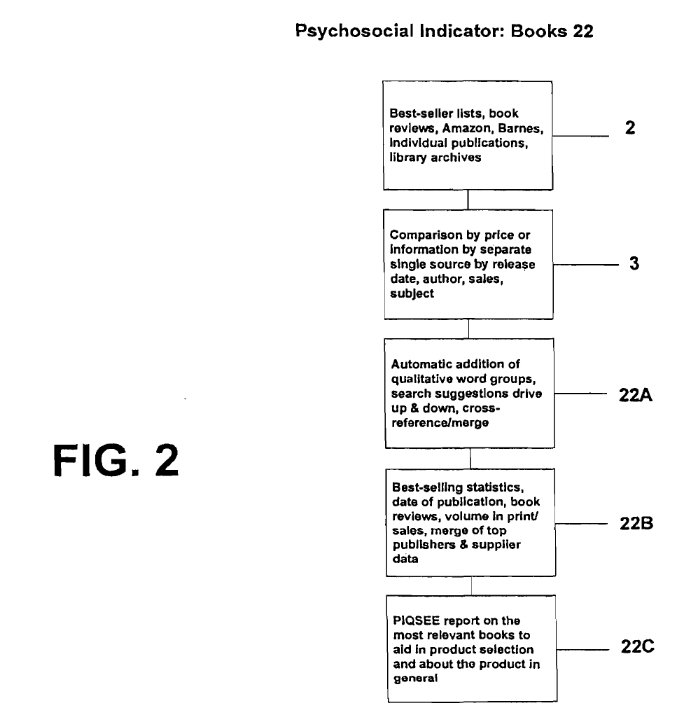

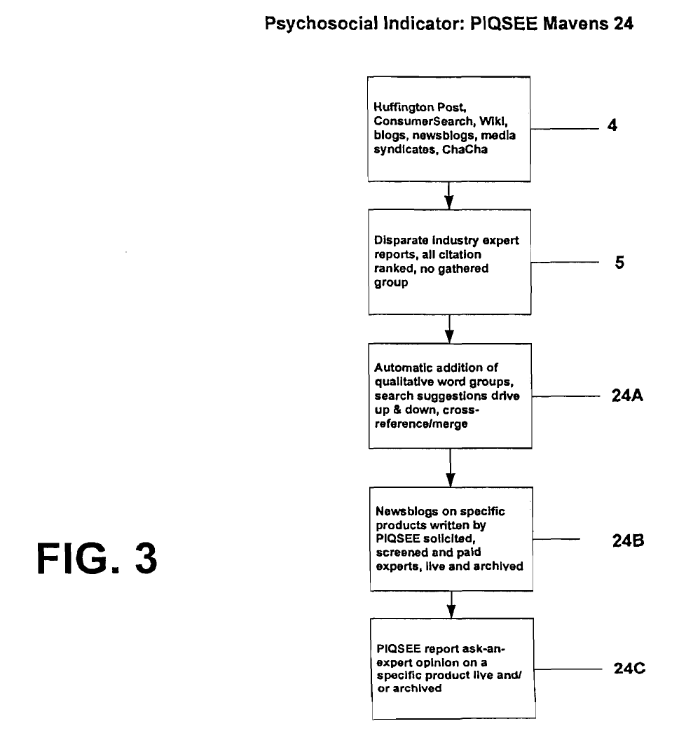

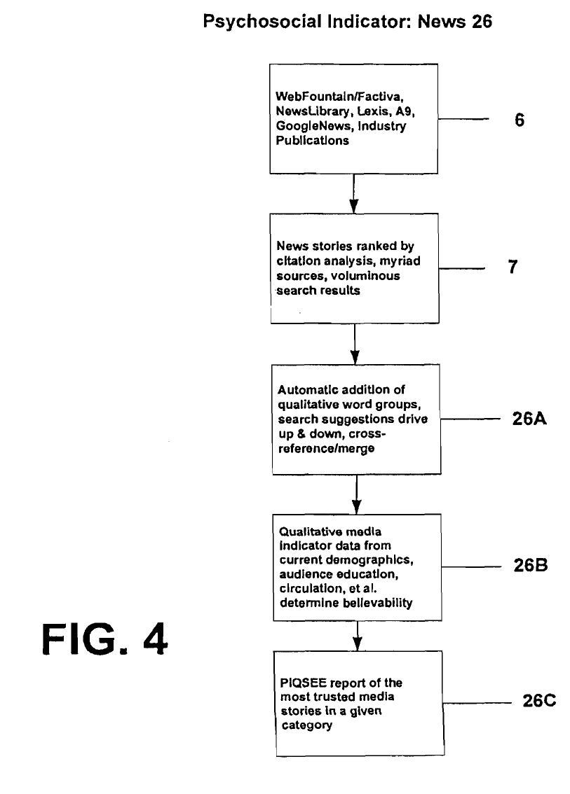

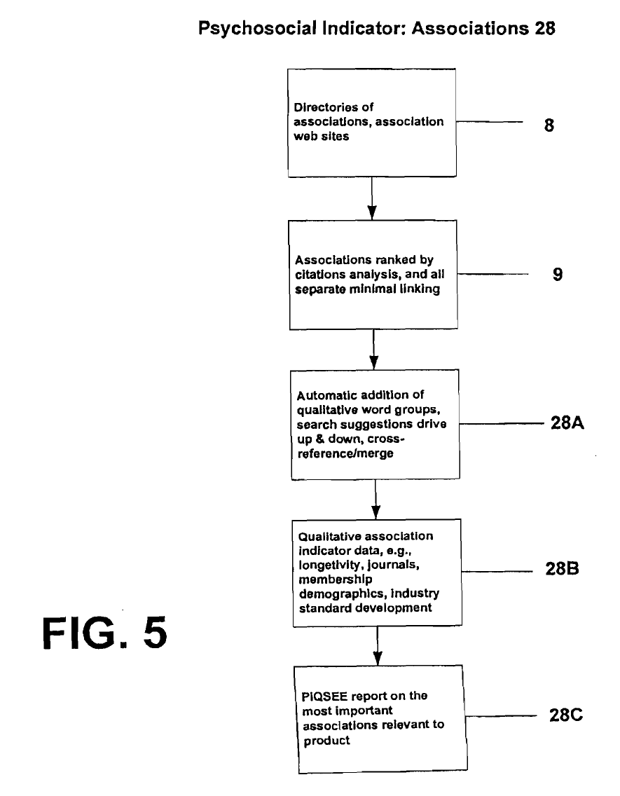

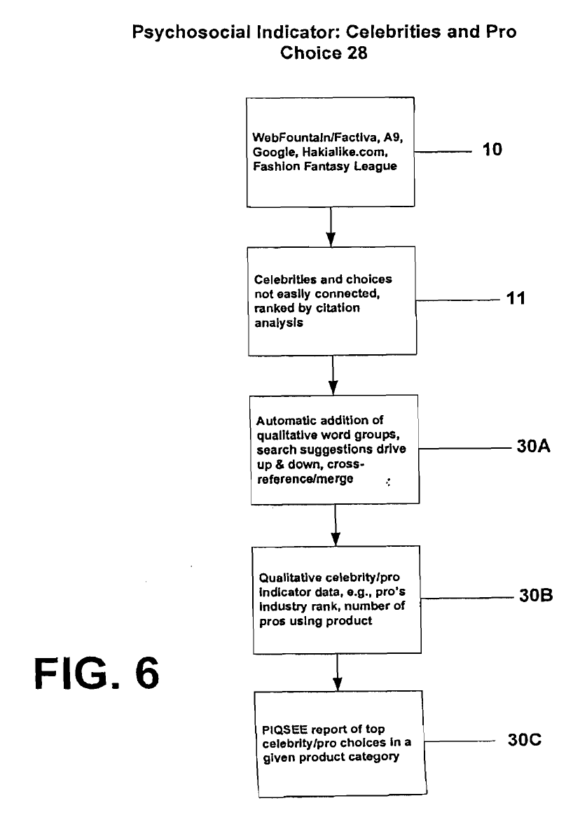

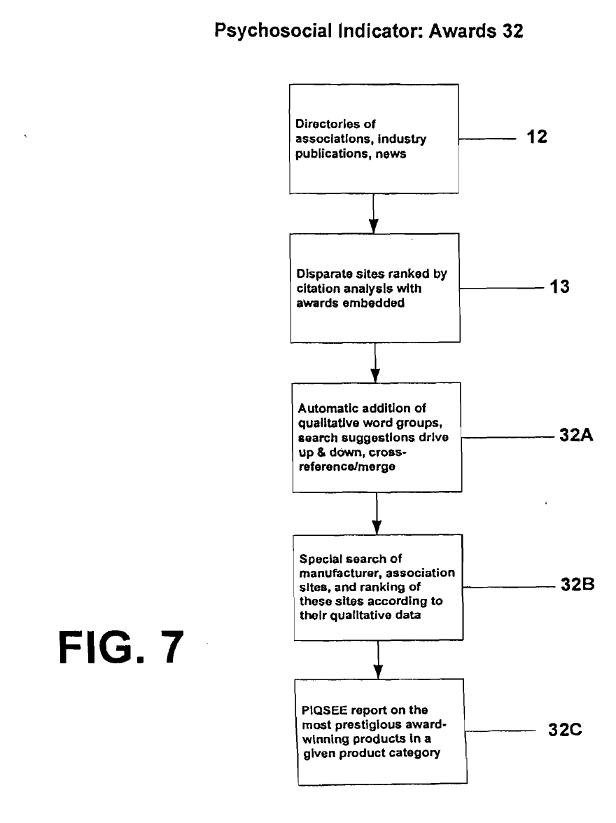

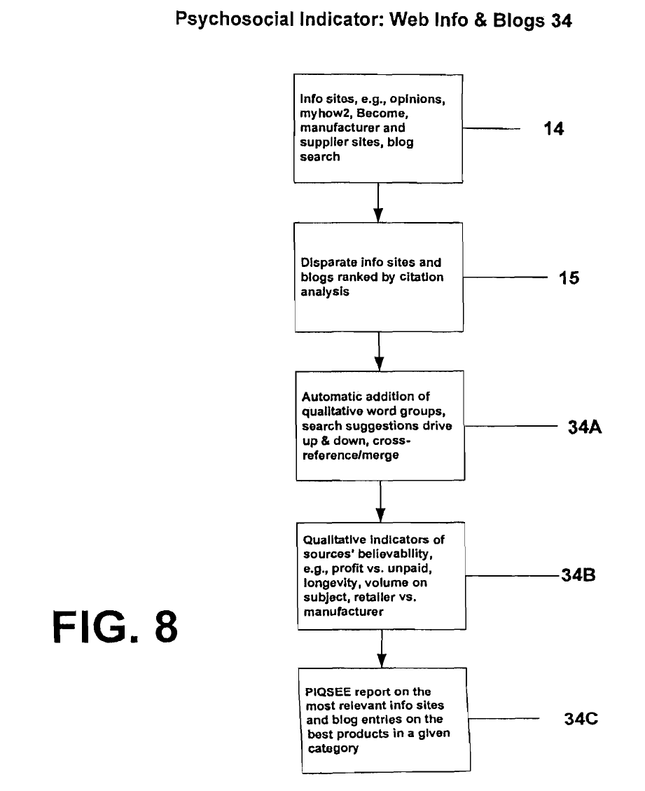

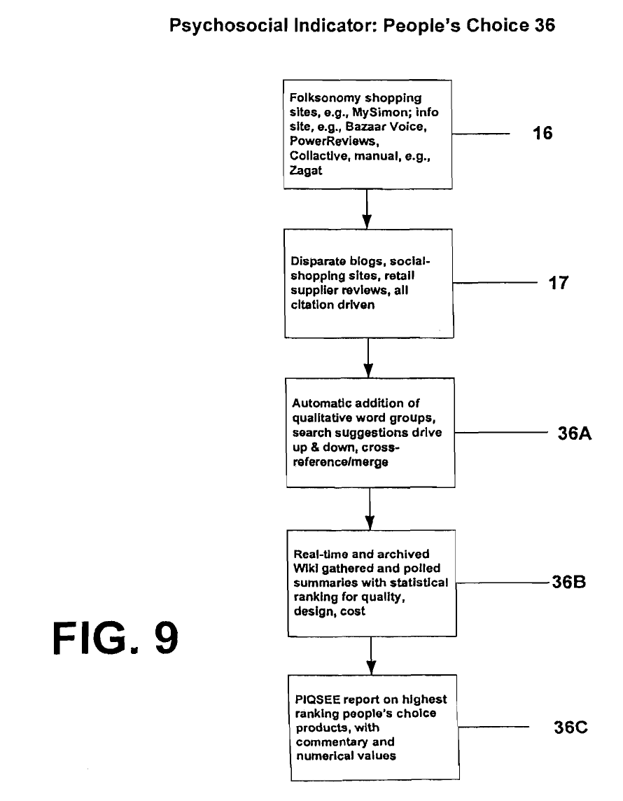

In particular, as shown in FIG. 1, the present invention 20 comprises a search path for each psychosocial indicator that includes five layers. The first layer in each of the psychosocial indicator (PI) paths comprises building blocks, precursors and sources layer, namely 2, 4, 6, 8, 10, 12, 14 and 16. By way of example only, these building blocks, precursors, and sources layer may comprise WebFountain/Factiva, A9, Hakia, Google, Yahoo, Wiki, newsblogs, NewsLibrary, PowerReviews, Zagat and Collactive. In particular, the first layer 2, 4, 6, 8, 10, 12, 14 and 16 for each of the eight PI paths is further defined in FIGS. 2-9. It should be noted that various filters delineated in FIGS. 2-9 are by way of example only and are not limited just to those mentioned; other filters may be included.

The second layer in each of the PI paths, namely, 3, 5, 7, 9, 11, 13, 15 and 17, comprises current search results: all semantic and is citation analysis driven. In particular, the second layer 3, 5, 7, 9, 11, 13, 15 and 17 for each of the eight PI paths is further defined in FIGS. 2-9. It should be noted that various filters delineated in FIGS. 2-9 are by way of example only and are not limited just to those mentioned; other filters may be included.

The third layer in each of the PI paths, namely, PIQSEE 20 general filters 22A, 24A, 26A, 28A, 30A, 32A, 34A and 36A are defined in FIGS. 2-9. This layer generally includes terms such as “best of,” “greatest of,” “top 10,” critics choice,” etc. It should be noted that various filters delineated in FIGS. 2-9 are by way of example only and are not limited just to those mentioned; other filters may be included.

The fourth layer in each of the PI paths, namely, PIQSEE 20 special filters 22B, 24B, 26B, 28B, 30B, 32B, 34B and 36B are also defined in FIGS. 2-9. It should be noted that various filters delineated in FIGS. 2-9 are by way of example only and are not limited just to those mentioned; other filters may be included.

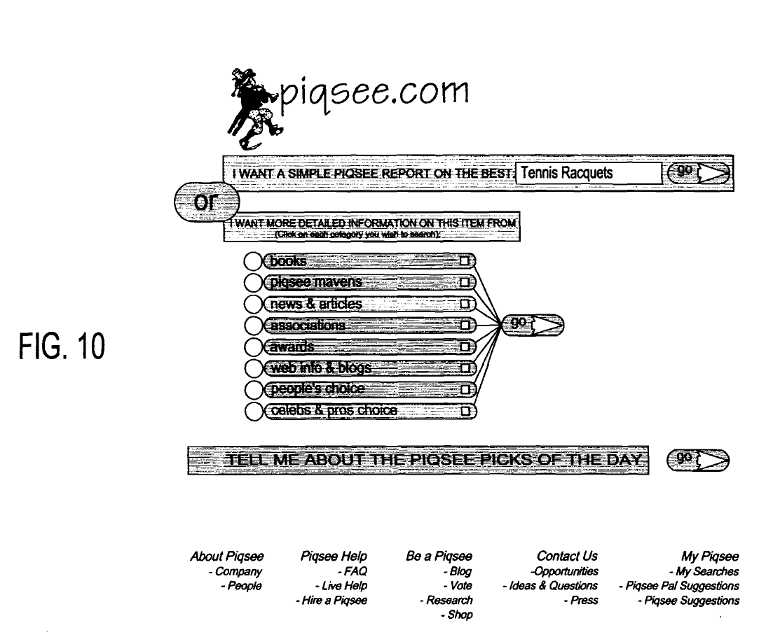

The fifth layer in each of the PI paths, namely, PIQSEE 20 report 22C, 24C (“expert opinion”), 26C, 28C, 30C, 32C, 34C and 36C are also defined in FIGS. 2-9. Operation of the present invention 20 is as follows. In step 1 (FIG. 1), the user or consumer inputs a keyword search query at the PIQSEE 20 website (not shown). The user is then permitted to have PIQSEE 20 concurrently search all PI paths and to provide a PIQSEE final or “simple” report or the user can instruct PIQSEE 20 to search on one or any combination of the PI paths. This can be seen most easily in the screen display of FIG. 10 where the user can select “I want a simple PIQSEE Report on the best” which involves concurrently searching all of the PI paths or he/she can select one or more of the PI paths (books, PIQSEE mavens, news & articles, associations, awards, web info & blogs, people's choice and celebrities and pros choice) which involves concurrently searching only the user-selected PI paths.

PIQSEE 20 ranking begins with the same filtration steps: first, with general information that is currently available on the web 22A, 24A, 26A, 28A, 30A, 32A, 34A and 36A; and second, with the application of wide range of qualitative word groups that serve as qualitative filters 22B, 24B, 26B, 28B, 30B, 32B, 34B and 36B. For example, someone might type in “tennis racquet,” and perhaps they might even type in “best tennis racquets.” There are many other words and word groups other than “best” that are used to identify quality though, and most people don't think of all the synonyms when they do web searches. PIQSEE's general filter 22A, 24A, 26A, 28A, 30A, 32A, 34A and 36A act as an automatic qualitative thesaurus, adding a whole range of additional words to the original request to generate a list of the best tennis racquets, including, but not limited to words such as: finest, experts rank, critic's choice, hot picks, superior, how to buy, how do I select, best money can buy, of the year, design, tips, professional choice, technological advances in, to the test, measure the degree, premium, of the year, etc.

Additional filtration within each category is specific to the category. Within each of these 8 categories or voices of authority, a natural ranking system takes place that has yet to be defined on the web. The ranking methodology for each category varies because the determinants of their value vary. As noted earlier, Google and all other searches are based on citation analysis and other secreted and ever-changing criteria. PIQSEE 20 is not only providing information about the best final products, but creating a ranking system within each category. The PIQSEE 20 ranking system within each category is developed by applying elements of intelligence that determine psychosocial status within each category, elements which have not yet been used in a filtration process.

News

Using the tennis racquet as an example, a search Google News Archives for tennis racquet yields 583,000 results (Jun. 15, 2008).

The way a consumer currently has to search for information about tennis racquet articles is to intuitively search through those half a million Google results, go to another general search engine (e.g., Ask, Yahoo,) to see what news stories might come up, go to individual publications that one thinks might have an article about tennis racquets, or look up all the publications that write about tennis (through a media directory like Bacon's or through web research) and then go to their archives.

PIQSEE 20 gathers all the potential consumer product media that currently exists in numerous different locations, and brings them all together as the basis for the vertical search engine for media.

A PIQSEE 20 search, as noted earlier, applies qualitative word groups as filters to the news.

A PIQSEE 20 news search for tennis racquets also ranks the news. One example of a criterion that can be used to rank news articles is the circulation or readership characteristics of the newspaper or journal. Everyone knows that the Wall Street Journal is a more trusted source for information than the National Enquirer. Why? One criterion, for example, is the education level of the average reader. Another is the income level of the average reader. Other factors might be such things as gender, purchasing patterns, date of publication, distribution outlets. An example of how this works is that a publication with a higher educated, higher income male readership is considered a stronger voice of authority in general and particularly related to male oriented products. A publication with a higher educated, higher income female readership is also considered a stronger voice of authority for feminine oriented products. If a publication has a high ratio of subscription to supermarket sales, then that also adds to its credibility. Newer or more current information is valued more. This information is available through industry sources such as Standard Rate and Data Service, Omniture, numerous web analytics, media kits demographic data of each publication. This data is commonly used by advertising agencies to determine which placements to purchase to get best exposure for their clients products. Similarly, public relations firms develop targeted lists of the most influential publications to target for their clients' products. The perception of influence or authority is based on the data, and this data is used to make business decisions. This data has not yet been used to help filter and rank the search process. PIQSEE's innovation is to take these sources and apply them in a unique way, as the filtration system determining qualitative ranking 26B.

After the filtration, what the consumer/end user gets is a ranked list 26C of the best products of a specific product type, as determined by ranked media. They are also able to continue down the list of ranked media references to the product. They are able to click on a specific media reference and see the whole media story. They also have various options to purchase the products.

Associations

Currently, if consumers want to find out what associations might have to say about a specific product, they have to first find out associations that deal with that product, or design of that product, design in general, or manufacturing, distribution or sales of that product.

PIQSEE gathers all associations in one place, drawing on such resources as the Society of Association Executives and the International Directory of Professional Associations. The universe of associations is the basis for the vertical search engine for associations.

Within the associations category, PIQSEE first applies the qualitative word group filters 28A mentioned in the summary above.

Another level of filtration is to rank the associations 28B. What PIQSEE does is to spider through associations and clubs, create a filter to rank the associations and clubs and then provide information about the product(s) in question.

When people buy a product, any endorsements, affiliations or information from associations using that product add to the prestige of the product. Marketers strive to develop affiliations with these associations. “The official tennis racquet of the______” gives immediate credibility. Mention of a specific tennis racquet in the newsletter of a tennis association gives credibility. A resource list provided on the website or in an association publication lends credibility.

The ranking criteria for the associations include, but not be limited to such things as longevity of the association, number of members, geographic scope, number of events, budget, board members, and in this case, citation frequency, awards won by the association, awards/scholarships/grants given by the association, qualitative word group articles about the association. These are the things that determine the prestige of the association, and this information is publicly available. This information matrix has never been overlaid as a filter to develop ranking system, and that is precisely what PIQSEE does.

Using these determinants, products, qualitative word groups and then ranking the associations produces a list that parallels and imitates the human thought process that makes these choices.

After the filtration, what the consumer/end user gets is a ranked list 28C of the best products of a specific product type, as determined by references made by ranked associations. They are also able to continue down the list of ranked association references to the product. They are able to click on a specific association reference and see the whole association reference. They are also able to click through to get full information about the association. They also have various options to purchase the products.

Celebrities and Pros

Currently, if consumers want to find out what products are being used by which celebrities, you would have to do general searches, linking the specific celebrity and the product, or you might go to a site like Fantasy Fashion League, or become.com, or the pages of tabloids, fashion, or industry specific publications to try to track down the connections. Even if you find the connections, they are not ranked in any way.

Within the celebrity and pros category, PIQSEE first applies the qualitative word group filter 30A mentioned in the summary above.

The marketing, advertising and public relations worlds spend huge amounts to have celebrities and professionals use their products, and are photographed with their product, and endorse or comment on their product. The celebrity sometimes receives fees for product usage and endorsement, but not always.

Continuing with the tennis racquet example, if Andy Roddick, one of the top players in the world currently, uses a certain tennis racquet, it holds huge influence over consumer trust and product sales. Celebrity and pro connection to products is a strong psychosocial indicator of public perception and ranking that has not been ranked prior to PIQSEE. Several publications and websites note what different celebrities may be wearing, of what products they may be using, but there is no ranking methodology.

What PIQSEE does is spider through the web for what celebrities and professionals are using what tennis racquets, and ranks the celebrities according to statistics that determine their ranking as a voice of authority for that product.

The next level of filtration is to rank the celebrities in connection with a specific product.

Celebrity and pros ranking is tied heavily to awards won by that specific celebrity or pro, but other elements from their biographies can also be taken into consideration, including but not limited to: level (national, regional, local) of awards won, number of years in an industry, spokesperson status for an industry association, spokesperson status for a product, income level and/or annual winnings, media references (also ranked using the media ranking filtration system above). With a product, professional ranking, for example, is weighed more heavily than celebrity. For example, it would weigh more heavily if Andy Roddick used a certain racquet instead of Paris Hilton.

After the filtration, what the consumer/end user gets is a ranked list 30C of the best products of a specific product type, as determined by connection to specific ranked celebrities and professionals. They are also able to continue down the list of ranked celebrity and professional references to the product. They are able to click on a specific celebrity or professional reference and see the whole reference in context. They also have various options to purchase the products.

Books

If consumers want to find books about a specific product or book mentions, they currently have to go to various separate sites to find that information, including booksellers, publishers, authors themselves, book reviews, and library indices.

PIQSEE 20 gathers together all these sites in one place as the general basis for the vertical book search engine.

Within the book category, PIQSEE 20 first applies the qualitative word group filter mentioned in the summary above.

Once information appears in print in a book, that information immediately holds a higher level of believability. Again, the whole marketing industry puts huge effort into establishing brand credibility via authors. When someone has published their own book or had a book published about them or their product, or has been included in a book in some manner such as in a dedicated chapter or even a simple mention, that person is positioned as a voice of authority. The relationship of a person or products to books is thus a key psychosocial indicator of their voice of authority and thus their amount of influence in consumer decision making.

Within the book world there is a ranking of credibility, and that is determined by various factors, some of which are noted in the above paragraph. PIQSEE 20 uses these factors in creating a ranking within the book search, along with but not limited to other data such as: bestsellers lists, quantities in print, quantities sold, library holdings, hardcover and soft-cover copies, number of editions, number of books by the same author, number of book mentions, consumer reviews, critics reviews, etc.

These factors are the elements of intelligent thought that a buyer uses in determining the hierarchical credibility of a particular book. PIQSEE 20 uses these elements of intelligence as a filter to determine the final output of information about a particular product.

After the filtration, what the consumer/end user gets is a ranked list 22C of the best products of a specific product type, as determined by connections to specific ranked books in print. They are also able to continue down the list of ranked book references to the product. They are able to click on a book reference and see the whole reference in context. They also have various options to purchase the products.

Awards

Currently, if consumers want to find out which products in a specific category have won some kind of awards, they have to do that search essentially manually. They need to know what industry or professional associations, organizations, consumer groups or media might give awards to that product category, and then they need to search each of these individually.

PIQSEE 20 begins this vertical search of awards by gathering together the bodies that might grant awards into one general group.

Within the awards category, PIQSEE first applies the qualitative word group filters 22A mentioned in the summary section above.

Looking again to the marketing world, a significant part of product positioning budget is dedicated to submitting nominations for awards, lobbying to procure these awards, and then publicizing the receipt of the awards won. The amount of effort is in direct proportion to the perceived importance of the award. A simple example, obvious to most consumers is that people pay more attention to the Academy Awards than the Golden Globe Awards.

PIQSEE 20 identifies the products in connection with awards, and creates a filter to rank the value of the awards. The ranking process includes a ranking of the organizations presenting the awards as explained in the association section above, in addition to numerous other factors. It must be remembered too that not all awards are presented by associations, but by other entities such as but not limited to periodicals (consider “Best of” issues and “People's Choice issues), other media outlets, individuals who create and publicly announce lists, guides (such as Zagat's) who rank and award a range of bests.

Some of the factors that influence the hierarchy and public opinion value of an award include but are limited to: quantity and quality (e.g., Major network vs. local cable) of airtime, amount of advertising, sponsorship relationships or lack thereof, amount and quality (again using PIQSEE news ranking filtration) of non-paid media coverage, data on award presentation, longevity of award, etc.

After the filtration, what the consumer/end user gets is a ranked list of the best products of a specific product type, as determined by a ranked list of awards received by products in the product category. They are also able to continue down the list of ranked products with awards. They are able to click on a specific product award and see the whole reference in context. They are also able to click on the awarding body and get information about the group giving the award. They also have various options to purchase the products.

Web Info and Blogs

Currently, if someone wants to find out who is writing web info or blogs about a specific product, they can go to sites like myhow2.com, the individual manufacturer sites, and blog search sites like technorati. All of these use quantitative (not qualitative) ranking.

PIQSEE draws on these and similar sites, gathering them together into one area as the basis for a vertical search of web info and blogs.

Within the web info and blogs category, PIQSEE first applies the qualitative word group filter 34A mentioned in the summary above.

The ease and simplification of web site design, video production and posting, and of blog creation have made it possible for everyone with computer access to have a voice, to have their own column. The flexible layout of the site, the optional interactivity, the relative frequency of postings, the lack of editorial oversight—all these web features give the term “freedom of speech” a new breadth of meaning.

Increasingly, consumers are turning to web info sites, video posts and bloggers as sources of information. Marketers are tracking and interacting with these online sources, trying to influence them just as public relations launched traditional media campaigns years ago.

Within the web world, certain sites have already emerged as having higher importance. The primary measurable data here is number of visits or what would be referred to as circulation in print media or viewership for TV. In addition to using this as a filter to rank these sites and the information on these sites, PIQSEE also uses a combination of other data to include, but not be limited to such things as media citation (using the ranking methodology discussed in the news section), mention in books, mention on other blogs or websites, biographical data as available, professional affiliation, awards, associations. In other words, PIQSEE filters become the additional filters for a ranking of web info and blogs which is now simply ranked by sheer volume or quantitative means as opposed to any qualitative filters.

After the filtration, what the consumer/end user gets is a ranked list of the best products of a specific product type, as determined by a ranked list of web info, blog and video sites about that specific product category 34C. They are also able to continue down the list of ranked web info, blog and video references. They are able to click on a specific product reference and see the whole reference in context. They are also able to click on the web info site, blog or video site and get more info about each of these sources in general. They also have various options to purchase the products.

People's Choice

Currently, if consumers want to get people's choice type information about a specific product, they would get it from the manufacturer's website if the manufacturer has a “rate this product” section, from an ecommerce retailer like eBay or Amazon who have “customer reviews” sections, media that might hold their own people's choice surveys, analysts like Forrester who prepare product category studies, or industry statistics and sales data. None of these sites “wiki” or join together all of the data in a summary fashion.

PIQSEE's people choice begins by gathering together all of the information sources that currently have to be researched individually.

Within the people's choice category, PIQSEE first applies the qualitative word group filters 36A mentioned in the summary above.

In recent years, public voting and comment systems have grown exponentially. Probably among the best known early successes in the consumer world is the Zagat restaurant and hotel rating system, where people literally mailed in ballots and gave numerical rankings to restaurants and hotels in specific locales; these were then tallied and summarized and published and distributed first as books, now online as well. Online customer reviews offered by giants like Amazon then, and through companies like Bazaar Voice for all ecommerce made it possible for instant, ongoing, real time consumer commentary to take place on the internet. The commentary is however, one person at a time and not summarized.

PIQSEE introduces people's choice by taking five steps: first by gathering and ranking current customer product reviews available on the web; second, by allowing additional commentary to be made; third, by tallying this current data and producing a summary wiki style; fourth, by allowing online real time voting to be tallied into the summary, wiki style; and fifth, by exhibiting the individual comments, the summaries, and the rankings.

After the filtration, what the consumer/end user gets is a ranked list of the best products of a specific product type, as determined by a ranked list of consumer comments. They are also able to continue down the list of ranked consumer comments, or across, getting wiki summaries or individual comments either about the top racquets or a variety of comments about one specific racquet. They are able to contribute a comment. They will also have various options to purchase the products.

Mavens

Currently, if consumers want to find a maven on the web, they have to determine who they consider a maven, or expert, and laboriously research and/or track them through individual columns or blogs or books. If they don't know who is an expert in a particular product category, they are stuck, unless they can describe the criteria by which you consider someone an expert and then backtrack on the web or offline to find people who match up with that criterion. Someone might search Good Housekeeping or Consumer Reports or ConsumerSearch, or maybe the Chamber of Commerce as general maven sources. They might narrow their search for a maven by going to industry associations or publications or speakers bureaus or book in print or media, Who's Who directories of biographical data.

PIQSEE's maven search begins by identifying all the general maven sources, and the loci where specific industry mavens are found. This becomes the basis of the maven search engine.

Within the maven category, PIQSEE first applies the qualitative word group filters 24A mentioned in the summary above.

Everyone knows a maven. They are the people you go to when you want to buy something, and you know they have the information you need. In the marketing world, these people are also currently called the “influentials.” Marketers target the influentials nowadays for the same reason political despots through history have targeted the intelligentsia and community leaders.

PIQSEE creates the mavens category by scouring the web and by association, cross referencing and filtering, identifying experts in product category areas. Have they written articles? Where (PIQSEE news ranking)? Have they appeared on television (PIQSEE news ranking)? Have they been published (self published or trade or academic? And again PIQSEE book ranking applied) Have they won awards (PIQSEE award ranking)? Have they done public speaking? Are they listed with public speaking bureaus? Do they have a website or blog (PIQSEE blog ranking)?

PIQSEE, in addition to the list mavens gather through the above mention methods, also develops a system to identify its own top experts in an area, and may accept and or request signature or byline reports from these specific individuals.

After the filtration, what the consumer/end user gets is a ranked list of the best products of a specific product type, as determined by a ranked list of maven/expert comments. They are also able to continue down the list of ranked maven/expert comments, or across, getting wiki summaries or individual maven reports either about the top products in a category or a variety of comments about one specific product. They are also able nominate themselves or others as mavens/experts. They also have various options to purchase the products.

In reviewing these 8 PIQSEE categories/vertical search engines and their respective filtration processes, it may be apparent that there is some overlap. For example, someone who is identified as a maven may appear as a reference on the book list or the articles list or in the awards list. There may indeed be overlap, and that is in part what gives PIQSEE its strength. The stronger a person or product, the more frequently it is seen to rank high in more than one category/vertical search. The ultimate final PIQSEE report takes this into consideration in preparation of the final simple PIQSEE report.

Another important note is that consumer patterns vary. One person wants the news ranking and doesn't care about associations. Another person values and prefers to consult other voices of authority. Individual consumers each have their own preferred sources they consult in product decision-making; the same person may also consult different sources depending on the type of product they want to purchase.

PIQSEE recognizes all these variables and decision making preferences and accommodates them.

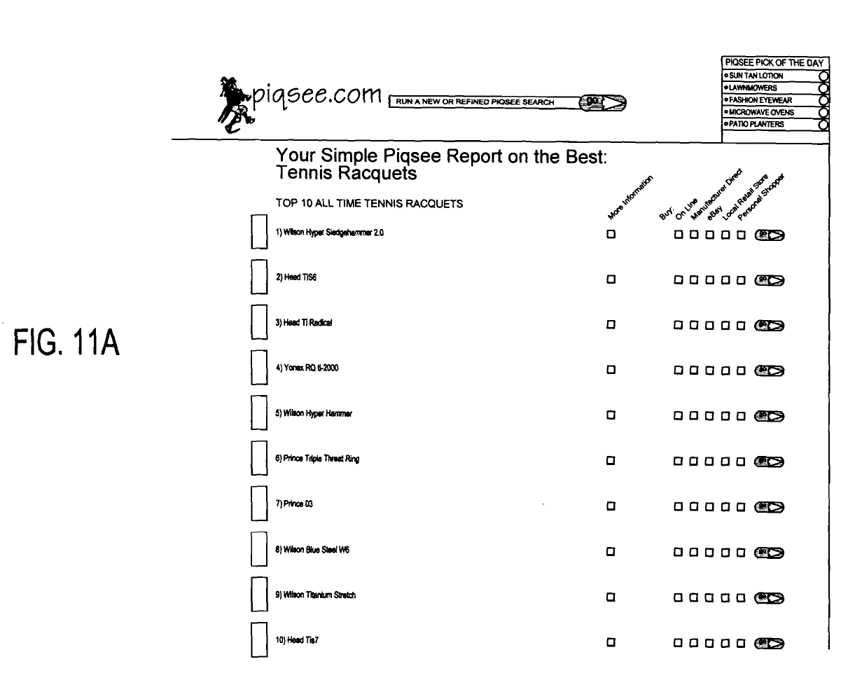

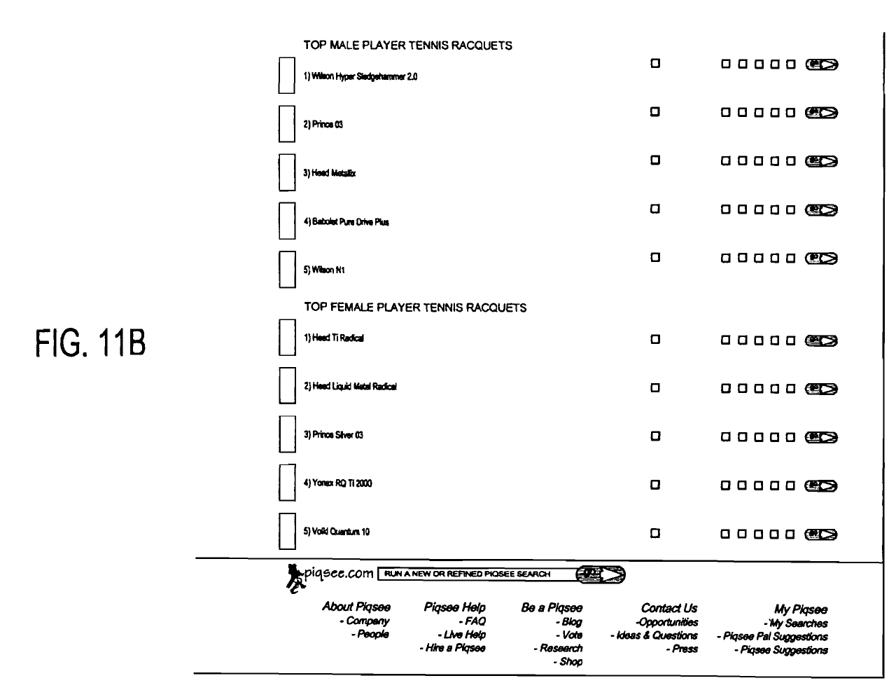

When each of the PI searches is completed (either all of them or anyone or combination of them), the results from each of the PI path searches is aggregated/merged in step 38 (“indicator ranking and combination”). Step 38 may use various kinds of ranking and combination mechanisms, e.g., weighting functions, to provide a qualitative ranking of the searched products, services, or topics. The final PIQSEE report can be created by the user in several ways. The present invention lists at least 8 voices of authority, and the user can choose one or more or all of the voices to create their final report. If the user opts to go straight to the final simple PIQSEE report, then all 8 voices of authority will automatically be included. As mentioned previously, based on the selection made by the consumer or user in the screen display shown in FIG. 10, a report is generated (e.g., on the display screen and/or by printing a hard copy). By way of example only, if the user were searching for the best tennis racquet and the user wanted all of the PI paths searched, the user would select the “go” button following the phrase “I want a simple PIQSEE 20 report on the best.” The PIQSEE method then concurrently searches for that product on all eight (or more) of the PI paths. The results are then aggregated/merged in step 38 and PIQSEE 20 generates the PIQSEE 20 final (also known as the “simple”) report as shown in FIGS. 11A-11B.

When the user chooses more than one voice of authority for their report, these voices too will be ranked, using two primary filtration systems: consumer psychology data that ranks the consumer trust index in the at least 8 voices of authority; and the weighting of information that appears in each of the 8 voices of authority reports.

Both of these filtration systems are organic and change according to the most current information about consumer trust, and data available within each voice of authority.

In one embodiment of the present invention, the consumer trust index indicates that the 8 voices of authority would be ranked by importance in this manner: news, books, celeb & pro choice, awards, people's choice, web info and blogs, associations, and mavens. This order statistically reflects the sources that most people go to find information to assist them in product decision-making.

An example of how this weighting will vary is evidenced most clearly in the area of blogs. Blogs would have been weighted more heavily a year ago, but with their proliferation and lack of any editorial controls, the level of consumer trust in their content has decreased, and therefore, their weighting within the PIQSEE final report would lower as well.

The weighting of the categories is also determined by the quality of information within each category. The number of significant entries in each category is important, but the nature of those entries is also taken into consideration. Which category has more international or national versus local citations? Which information is cross referenced in other categories? Which categories have the highest number of high-weighted entries within them based on the ranking criteria within that category?

An example here is when a product has won two awards but they are both local, and they have one nationally ranked professional using the product; then the national professional notation has heavier weighting. In other words, the highest ranking products will come up within each category or voice of authority, but within that voice of authority, there could have been other products with higher positions, but none evidenced association with the higher ranking criteria.

The PIQSEE final report 40 gives the consumer/user a list of the top products in the requested product category; if requested, the most relevant information within each voice of authority information category; if requested, information in all the voice of authority categories about specific products within the requested product category.

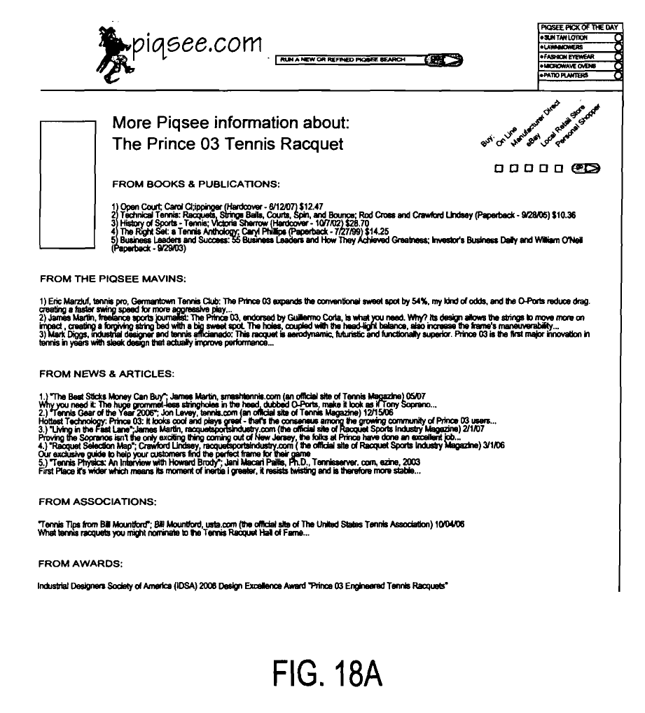

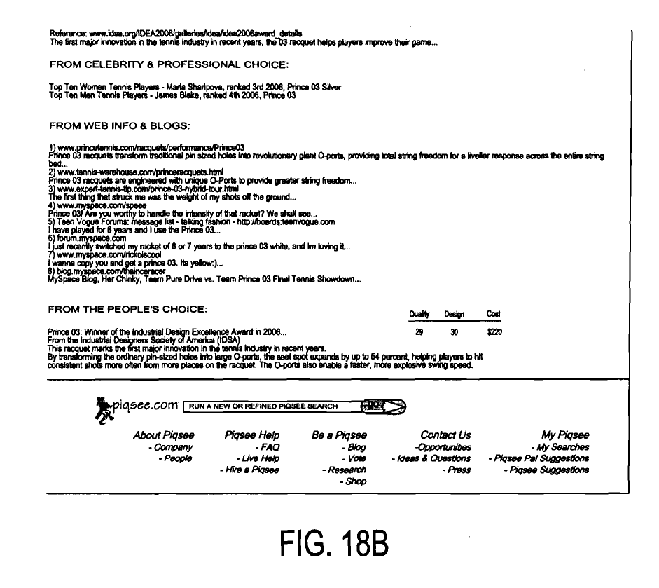

As shown in those figures, the end result of combining the search results from each of the PI paths 22-36, provides an overall listing of the best tennis racquets (again, by way of example only), with the most preferred being presented as “1” and the least preferred being presented as “10”; other subcategories, e.g., “top male player tennis racquets” and “top female player tennis racquets” are also displayed in ranking order. It should be noted that the format of the PIQSEE 20 final report is strictly a ranking with not much detail about the individual PI search path results. This is preferred by many consumers who just want to know the ranking without being overwhelmed by a lot of detail. Moreover, the PIQSEE 20 final report screen display permits the user to then purchase the particularly ranked item by different methods (e.g., “online, manufacturer direct, eBay, local retail store, personal shopper, etc.). If, after selecting the PIQSEE 20 final report, the user does want more information on a particular ranked item, he/she can select the “More Information” button. By way of example only, by selecting the “More Information” —the “Prince 03” tennis racquet relating to the eight consumer trust factors, the result is shown in FIGS. 18A-18B.

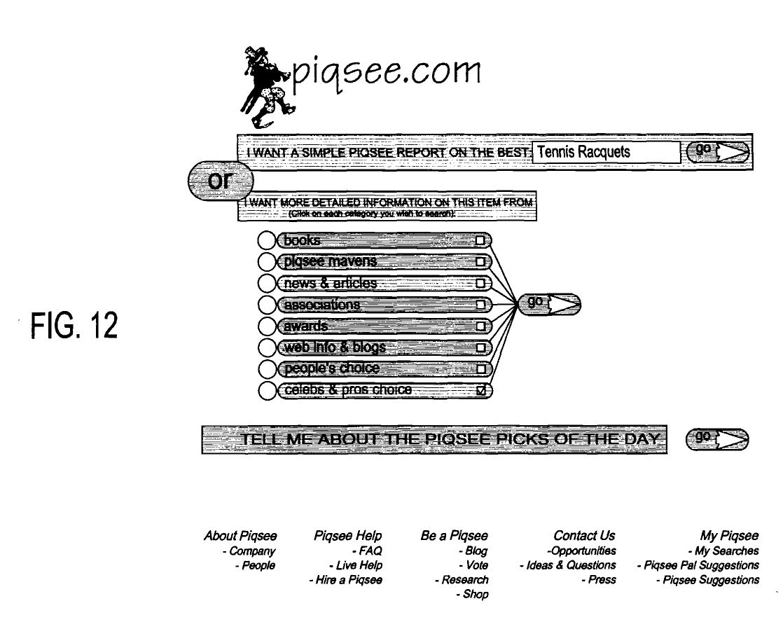

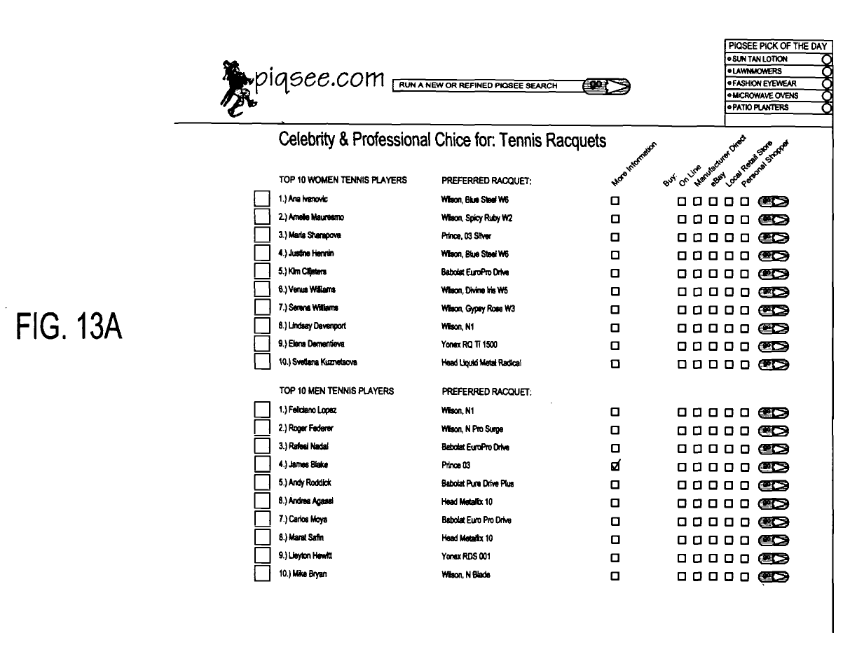

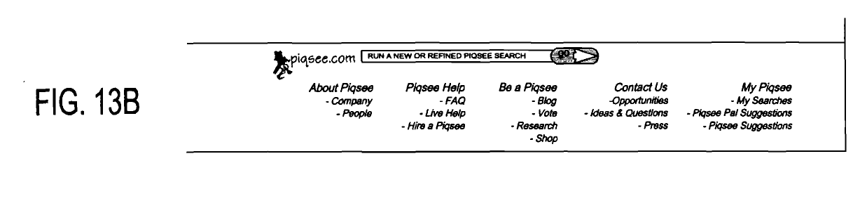

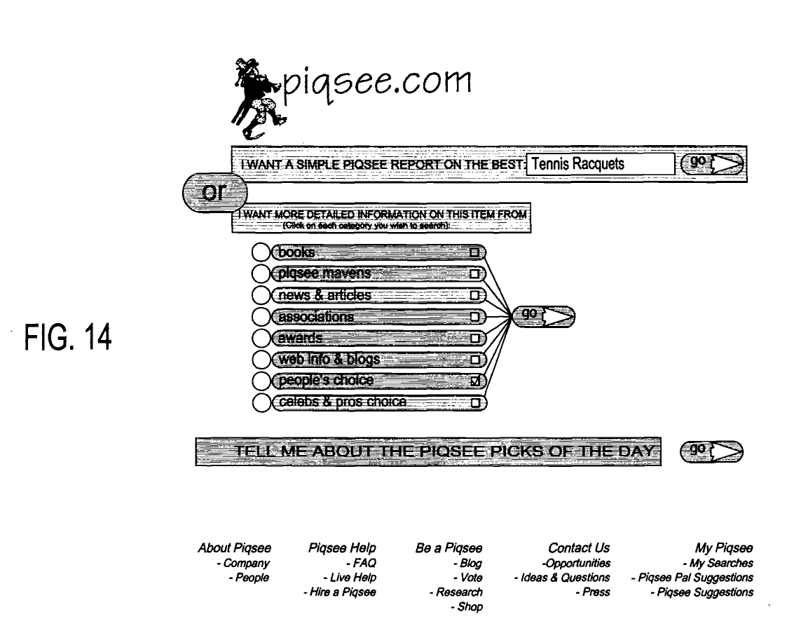

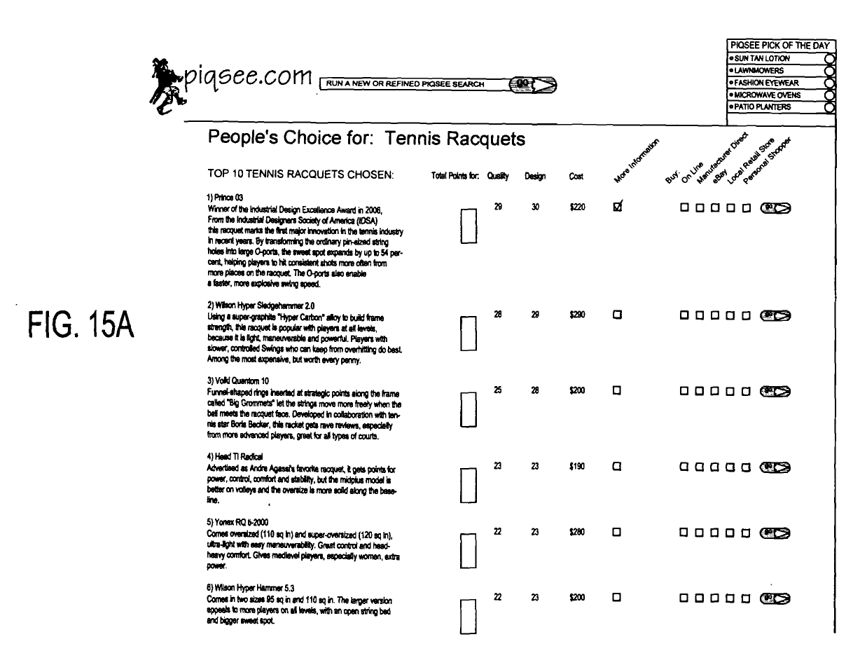

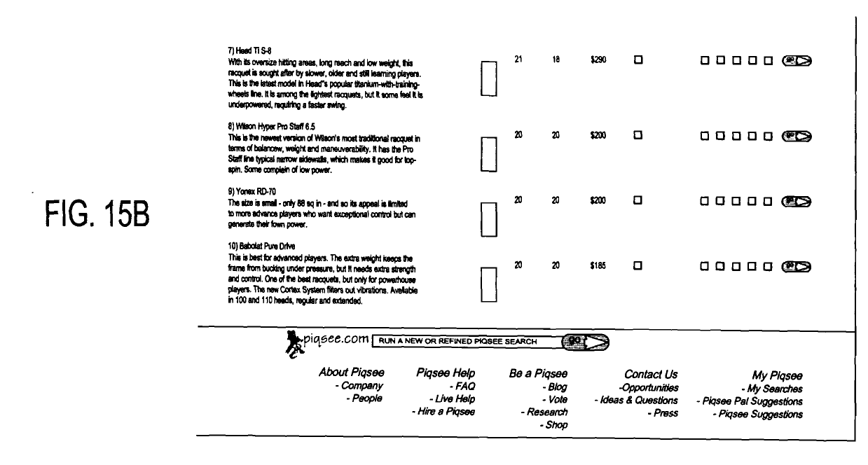

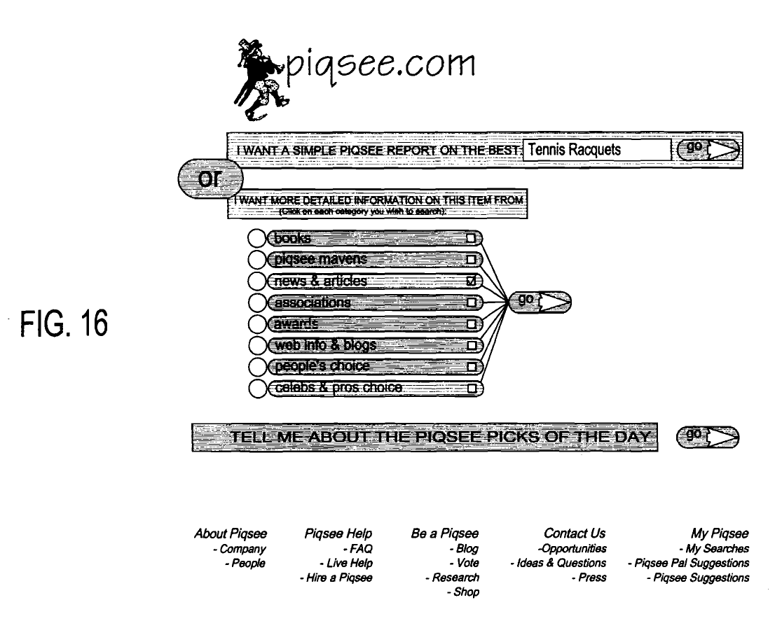

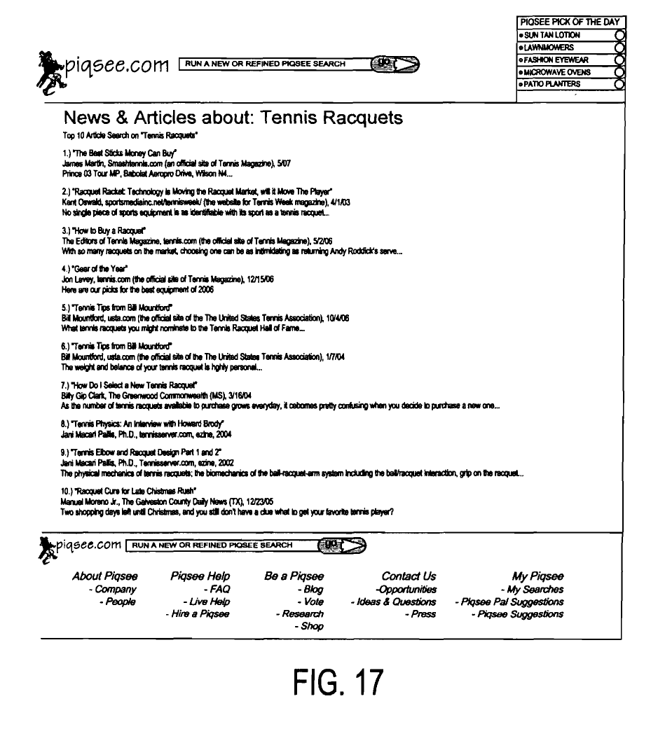

If, on the other hand, the consumer or user wants to select which PI path or paths to have PIQSEE 20 search, the user selects the particular PI path or paths shown in FIG. 10; in particular, he/she selects the box following any or all of the eight PI paths. By way of example only, if the user wants to search only the celebrity & pro choice path search, he/she would select the box after that PI category (FIG. 12) and the result of that search is the screen display (and/or hard copy) of FIGS. 13A-13B. If the user wants to search only the people's choice path search, he/she would select the box after that PI category (FIG. 14) and the result of that search is the screen display (and/or hard copy) of FIGS. 15A-15B. If the user wants to search only the news & articles path search, he/she would select the box after that PI category (FIG. 16) and the result is the screen display (and/or hard copy) of FIG. 17. Although not shown, the consumer or user can select any combination of these PI categories. Where one or more of the PI paths is selected by the user, but not all of the PI paths are selected, the indicator ranking and combination step 38 takes this into account during the merge. Thus, the consumer or user can select which PI path, or combination of PI paths, or have all PI paths, implemented in searching for a product, service or topic using PIQSEE 20.

Consequently, the results of the PI paths of consumer trust can be viewed individually, selectively grouped or all combined in the final report, i.e., the consumer or user can then have a report generated for the search results from that particular PI path or combination of PI paths. It should be further understood that the although the individual PIQSEE 20 reports 22C, 24C, 26C, 28C, 30C, 32C, 34C and 36C form the fifth layer in the PIQSEE 20 method 20, the actual report is not necessary as input to the indicator ranking and combination step 38. In other words, once the results from the fourth layer of each of the eight PI search paths are available, these results can be inputted to the indicator ranking and combination step 38; the actual report is for user convenience.

It should also be understood that the use of the present invention 20 is applicable to both products and services and that where the term “product” is used in the figures (e.g., see FIG. 1) and the Specification, services can just as easily searched. Thus, the term “product” is used by way of example and not by way of limitation and that the term “product” includes “services” also.

A sample search illustrates this. A recent search on Google for “tennis racquets” offers up 1,430,000 results in 0.25 seconds. As marketer Seth Godin wrote in his latest book The Dip, “[w]ith limited time or opportunity to experiment, we intentionally narrow our choices to those at the top.” If one wanted to limit his/her choices to access Godin's “top,” that person could add the word “best” and by entering “best tennis racquets,” and one could narrow the results down to 25,500 in 0.37 seconds. But that still is a brobdingnagian amount of data for the average person to sift. Furthermore, the first page of results is filled with obvious commercial sites written by manufacturers. Would a consumer trust these? The perception of authority or importance to the consumer is immediately compromised.

As also mentioned previously, the consumer who is searching for “tennis racquets” on PIQSEE 20, by contrast, has the choice of receiving a short summary report based on a merge of the voices of authority/psychosocial indicators—a simple top ten list; or, if they want yet more information, they can get the top ten entries within anyone of the voice of authority/psychosocial indicator categories. See FIGS. 10-18B regarding sample PIQSEE 20 reports for tennis racquets.

The key concept of PIQSEE 20 is then the identification of the most important, trusted voices of authority and their psychosocial indicators in one place, and the merging of these indicators, ultimately resulting in the simplification of the consumer research process.

Additional functional features of PIQSEE 20 include options on how to get assistance: search suggestions, live help, personal shopping service; how they want to make a purchase: manufacturer direct, local store, retail, price or personal shopper; how to get involved: become a maven, vote in people's choice, blog.

The following discussion compares the present invention 20, PIQSEE 20, to recent semantic web search engines but none of which use psychosocial indicator filters:

A9

A separately branded and operated subsidiary of Amazon.com, A9 debuted in the spring of 2004, employing Google's index of web sites, and layering on top a robust interface as well as integrating Amazon's “Search Inside the Book” feature. A9 is the first search engine to employ the concept of search history tracking personal clickstreams. While it does pre-select certain categories (web by live, books by Amazon, reference by answers.com, news by live.com, Wikipedia, all Amazon), it is a general, not consumer-oriented site and it does not use any psychosocial filters to pre-select or rank categories of information to assist in purchase decision making.

Answers.com

This site is advertised as “the world's greatest encyclodictionalmanacapedia.” It presents reference content in over four million entries, collected from multiple sources. Launched in March 2005, Answers.com is derived from one of the first downloadable smart reference search engines, first known as Atomica then as GuruNet. Answers.com performs a vertical search within a given set of top general information sources and provides a report of these to include: a dictionary definition, encyclopedia definition, wordnet, wikipedia, translations, and names of shopping sources.

Similarity to the present invention PIQSEE 20 exists only in the most general sense: it is a search engine, it uses select sources, and its report is concise rather than lengthy. Answer.com uses select sources, as does PIQSEE 20, but then with PIQSEE 20, sources vary from item to item, and have distinct sets of filters.

Also, PIQSEE 20 is a shopping site, not a general information site. Someone who comes to PIQSEE 20 already knows the general definition of the item he/she wants; what the person is looking for is qualitative information from trusted sources to help him/her make a decision about which racquet to buy and where to buy it.

Factiva

Factiva was founded in 1999 as a joint venture between Dow Jones & Company and Reuters Group. It was acquired by Dow Jones in December 2006 and from its corporate statement, “provides essential news and information together with the content delivery tools and services that enable professionals to make better decisions faster.” Factiva is powered by IBM's WebFountain, one of the most sophisticated, advanced semantic search engines in existence.

However, Factiva is not geared to consumers as PIQSEE 20 is, but professionals, and it is fee based, while PIQSEE 20 searches are free, and Factiva does not use any qualitative filters, nor any psychosocial indicators.

Hakia

Hakia advertises that it is “building the Webs new ‘meaning-based’ search engine with the sole purpose of improving search relevancy and interactivity, pushing the current boundaries of Web search. The benefits to the user are search efficiency, richness of information, and time savings. “Theirs is a venture in the semantic Web direction. Search results are smaller, but similar to Google, while they are designed for all Web searchers, they note they will especially appeal” to those engaged in research on knowledge intensive subjects, such as medicine, law, finance, science, and literature.

Powerset

Powerset is not yet operational, expecting to release the search engine to the public by the end of 2007. It will be powered by Xerox Corporation's “natural language” technology developed by the company's Palo Alto Research Center (PARC). Users will be able to type queries in plain English, rather than using keywords. This is another of the semantic Web advances which serves as a building block for PIQSEE 20, but it is not competitive in any way.

Powerset does promise to deliver higher quality search results, but it is a general search, not geared specifically to consumer product queries, and it makes no indication that it will assist in consumer decision-making in any way.

Snap

In the fall of 2004, Bill Gross introduced SNAP, a new breed of search engine that ranks sites by factors such as how many times they have been clicked on by prior searchers, taking pay-per-click one better: advertisers can sign up to pay only when a customer converts, i.e., when the customer actually buys a product or performs a specific action deemed valuable by the advertiser, like giving up an e-mail address or registering for more information. Snap offers some special functional features: fast visual displays of search results; offering popular search terms and synonyms; interactivity with a result without leaving the site; analysis of past personal search patterns. Snap offers improvements in search engine development, but it is linear, following the pattern of its predecessors. These are building blocks in search technique, but Snap is not specifically addressed to consumers and there are no psychosocial indicator filters or attempt to provide decision-making information to assist in purchase.

The following are recent semantic web advances but also none of which use psychosocial indicator filters. The four top search engines have set up a new generation of search engines where they are trying out new tools and features on consumers. These sites generally stick to the same set of search results found on the branded, parent site, but re-organize them and package them in new ways. They are general in nature, not geared to consumer products, and while they do provide smaller sets of results, the results are still not geared to information to help make a choice in purchase.

The sites, parents and their relative differences are: SearchMash.com/Google—offers blog, video, image and Wikipedia results; a hide button allows a user to collapse results to fit more on one page; the site rotates new features in and out every several weeks Alltheweb.com Nahoo—starts suggesting queries and refreshing results accordingly as soon as a user starts typing; a “refine search” menu allows updating settings to search only certain file types, like Microsoft Word documents. MsDewey.com/Microsoft—live avatar “host” talks back at the user with scripted phrases very loosely based on the query; the process is entertaining but the search results are not visibly different in any way AskX.com/lAC Interactive—users can switch between Web, image and video search results by clicking menus, and other search categories such as news and encyclopedia results also appear.

The following are live search advances but they too do not use psychological indicator filters.

ChaCha

ChaCha advertises that it “combines the best of the web's search engines with the human intelligence made possible by our vast community of skilled search experts.” Users have a choice of doing a ChaCha search on a product, which produces a smaller version of a Google search, or selecting an online live search assist with a ChaCha guide (30,000 in number by March 2007, predicted to number 300,000 by June).

ChaCha is a general search engine based on current search engines and produces similar results. The only similarity to PIQSEE 20 is the ability to get online live help. In the PIQSEE 20 model, live online help is only one of several help options. PIQSEE 20 is based on principles of shopper mode variance, i.e., different people want different levels of assistance, and offers various levels of assistance: suggestions immediately computer generated, not dissimilar to various current search engine automatic assists “you might also search . . . ”; live help like

ChaCha's system; ability to hire a personal shopper at a given fee.

The following is a comparison of PIQSEE 20 with folksonomy search advances but none of these use psychological indicator filters.

In late 2004 and 2005, a new kind of tagging scheme arose, based on the wisdom of the crowds. Small start-up companies like Flickr (store, search, sort and share photos), Technorati (a weblog search engine) and deLicio.us (a link-sharing site) begin to give users the ability to tag anything they see, and share those tags with others. The wisdom of crowds theory is that ultimately a kind of relevance for any given item emerges. Early bloggers dub this approach as “folksonomies” —folk+taxonomy.

A new crop of sites are marrying the social networking aspect that tagging allows, along with shopping information. ThisNext, Kaboodle.com, Wists.com, StyleHive.com, Zebo are spearheading a new category of e-commerce called “social shopping,” designed for blogging, browsing and shopping. Users create their own pages to collect information on items they find, post images of those products, and the social services sites then post pictures of items that have been viewed or circulated widely among visitors who have searched the site.

The PIQSEE 20 “People's Choice” is product-driven, with information organized to help in choosing among various products, whereas the current social shopping sites are individual focused and personality-driven. PIQSEE 20 uses tagging and shopping folksonomies as a building block, and allows its users to tag and share their PIQSEE 20 history, but this is not the unique defining element of PIQSEE 20. PIQSEE 20 users will have the option of posting and sharing their personal picks, but more importantly, they will be able to vote in “people's choice,” and their comments, using a wiki approach will be merged to produce a short summary report and numerical grades for design, quality and cost, and of even greater importance, this PIQSEE 20 “People's Choice” merged data is then flow into a final PIQSEE 20 report that takes 7 other psychosocial indicators into consideration. As a note, the PIQSEE 20 “People's Choice” system may, at a later date, be submitted for a separate technology patent.

The following is a discussion of new advances in price comparison and local source sites but yet none of them use psychosocial indicator filters.

The shopping comparison services, which aggregate prices from hundreds of different sites, have been around for almost a decade. Early versions focused on specific items or item categories such as computers or digital cameras. In the late 1990's, when many e-commerce ventures crashed, comparison-shopping sites survived, in some cases by combining forces with competitors. Use of these sites has boomed in the past few years as people have become more reliant on the Web both as a research tool and as a place to shop.

The more established sites include: Shopping.com, Shopzilla, Bizrate Pricegrabber, Pricerunner.com, and Nextag, as well as the shopping sections of Yahoo, Google, and Microsoft's MSN.

IoNow, a new crop of star-ups is pushing price comparison even further; Smarter.com now includes coupons and additional retailer discounts, Vendio Services recently introduced a downloadable toolbar that flashes alerts when a lower price is found; BuySafe lets consumers search among 1.5 million products that are backed by antifraud guarantees; Like.com offers visuals.

Sites like MySimon, Become and ConsumerSearch are the closest precursors to PIQSEE 20. MySimon offers a general search, but also singles out a few popular products, offers consumer reports on a few items, and provides some select shopping guides. Become's research option is broader, offering information in the categories of: reviews, buying guides and other shopping advice. ConsumerSearch offers the most detailed reports on items, but as the first are compiled via Web spiders, Consumer Search is handled editorially and hence its universe of items is the most limited.

BazaarVoice, is not geared to consumers, but to retailers, offering them a service that solicits, screens and analyzes consumer reviews on their behalf, and also collects reviews of specific products and distributes these reviews across select portal sites. PowerReviews, by contrast, does not charge retailers for its service, but posts reviews to both their own site and the retailers' site. These might be best classified as a web version of a consumer survey.

Like PIQSEE 20, these precursor sites are only similar in that they are intended to assist in decision-making and offer some research information, but they differ vastly in these areas: the results they produce are still a large universe that needs to be weeded; the results found within each category are from various types of sources with varying degrees of credibility; the research information categories are broad-brush, not as clearly delineated as PIQSEE 20; the research information categories are not filtered by psychosocial indicators; the research information categories have no separate ranking within other than that used by existing search engines; the research information categories are not merged to provide a final qualitative report.

Regarding the local search engines, the notables include NearbyNow, Yokel.com, Google's Froogle Local, BrandHabit, Shoplocal, Yelp, MojoPages. The ability to identify a local bricks-and-mortar product source is viewed as only one aspect of PIQSEE 20's site, and as such is one of the building blocks. In the buy options, PIQSEE 20 offers: manufacturer direct, online price comparison, local, eBay, and personal shopper sources.

Other sites do offer buying options, none typed to varying consumer service levels, and this merge of options may engender a later technology process patent.

It is the PIQSEE 20 methodology, which clearly delineates and merges the information sources most trusted and sought after by consumers, that is unique, compelling and heretofore not applied anywhere on the Web.

While the invention has been described in detail and with reference to specific examples thereof, it will be apparent to one skilled in the art that various changes and modifications can be made therein without departing from the spirit and scope thereof.

### Example Computing Environment

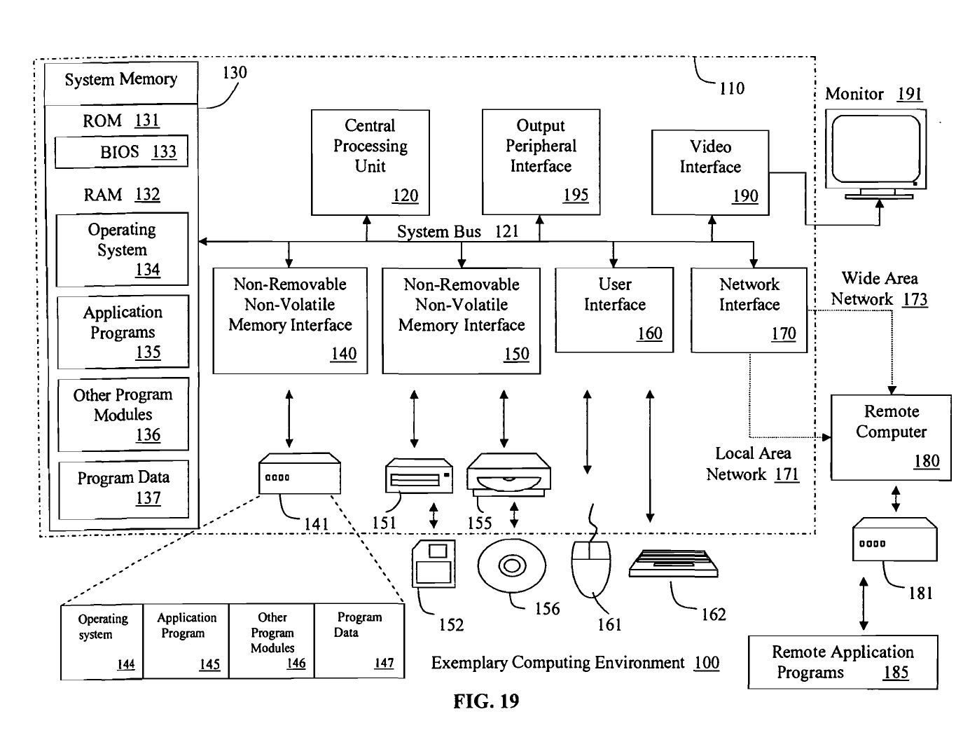

FIG. 19 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 19 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or a combination of components illustrated in the exemplary operating environment 100.

With reference to FIG. 19, an example system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), and PCI-Express bus.

The computer 110 typically includes a variety of computer readable media. Computer readable media can be any available media that can be accessed by the computer 110 and includes volatile and nonvolatile, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by the processing unit 120. By way of example, and not limitation, FIG. 19 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 19 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 19 provide storage of computer readable instructions, data structures, program modules and other data for the computer 110. In FIG. 19, for example, the hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers and a printer (not shown), which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 19. The logical connections depicted in FIG. 19 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes means for establishing communications over the WAN 173, such as the Internet. In a networked environment, program modules depicted relative to the computer 110, or portions thereof, may be stored in the remote memory storage device. By way of example, and not limitation, FIG. 19 illustrates remote application programs 185 as residing on a memory device 181. Remote application programs 185 include, but are not limited to web server applications such as Microsoft® Internet Information Services (IIS)® and Apache HTTP Server which provides content which resides on the remote storage device 181 or other accessible storage device to the World Wide Web. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

### Example Network Environment

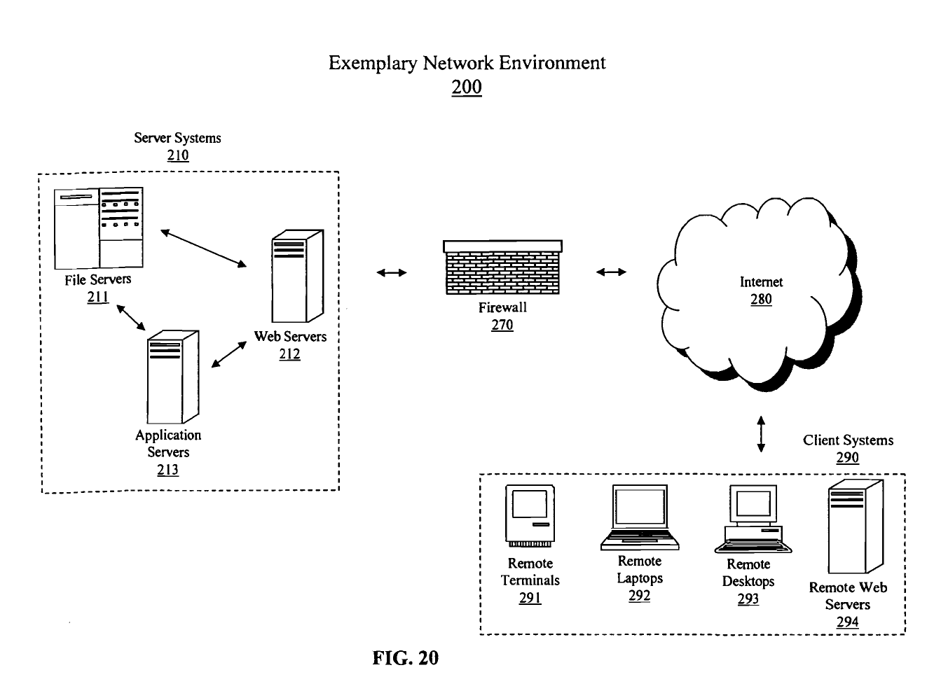

FIG. 20 illustrates an embodiment of a network environment in which an embodiment of the present invention can be implemented. The network environment 200 contains a number of server systems 210, which may include a number of file servers 211, web servers 212, and application servers 213. These servers are in communication with a wider area network such as the Internet 280 though typically some network security measures such as a firewall 270. A number of client systems 290 that are in communication with the server systems 210. The client computer systems can be a variety of remote terminals 291, remote laptops 292, remote desktops 293, and remote web servers 294. Service requests are sent by client systems 290 to the server systems 210 via the network 280. The server systems 210 process the service requests, and return the results to the client systems via the network 280.

FIG. 20 illustrates an exemplary network environment. Those of ordinary skill in the art will appreciate that the teachings of the present invention can be used with any number of network environments and network configurations.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is rather intended to include all changes and modifications that are within the scope and spirit of the invention.

What is claimed:

1. A method of providing a search engine for use on global computer networks which identifies and merges categories of information that reflect, influence and imitate intelligent choice, said method comprising the steps of:
concurrently searching a product, service or topic using one or more of psychosocial indicators of books, experts, news and articles, associations, celebrities and pro choices, awards, global computer networks information and blogs, and people's choice to generate respective search results for each of said indicators;
arranging said search results for each of said indicators from most credible to least credible; and
combining said filtered search results of said indicators to form a report that ranks the searched product, service or topic from most preferred to least preferred.

2. The method of claim 1, wherein said step of concurrently searching comprises four layers for each of said indicators, said layers comprising:
activating building blocks, precursors and sources as a first layer to generate first layer results;
inputting said first layer results into a second layer comprising semantic and citation analysis searching to form second layer results;
inputting said second layer results into a third layer that comprises general filtering based on the respective category to form third layer results; and
inputting said third layer results into a fourth layer that comprises special filtering based on the respective category to form fourth layer results.

3. The method of claim 2, further comprising the step of generating a report for a respective indicator.

4. The method of claim 1, wherein said step of combining said search results comprises applying weights to the search results from each of said indicators.

5. The method of claim 2, wherein said special filtering for said indicator of books comprises searching best-selling statistics, date of publication, book reviews, volume in print/sales, merge of top publishers and supplier data.

6. The method of claim 2, wherein said special filtering for said indicator of experts comprises various news sources on specific products, services or topics written by known experts.

7. The method of claim 2, wherein said special filtering for said indicator of news comprises qualitative media indicator data from current demographics, audience education, circulation which determine believability.

8. The method of claim 2, wherein said special filtering for said indicator of associations comprises qualitative association data, longevity, journals, membership demographics and industry standard development.

9. The method of claim 2, wherein said special filtering for said indicator of celebrities and pro choice comprises qualitative celebrity and proc indicator data including industry rank a number of pros using the product or service.

10. The method of claim 2, wherein said special filtering for said indicator of awards comprises manufacturer data, association sites and ranking of said association sites according to their qualitative data.

11. The method of claim 2, wherein said special filtering for said indicator of global computer networks information and blogs comprises qualitative indicators of sources' believability including paid versus unpaid, longevity, volume on subject, and retailer versus manufacturer data.

12. The method of claim 2, wherein said special filtering for said indicator of people's choice comprises real-time and archived data and polled summaries with statistical ranking for quality, design and cost.

13. A system of a search engine for use on global computer networks which identifies and merges categories of information that reflect, influence and imitate intelligent choice, said system comprising a web server that performs the steps of:
concurrently searching a product, service or topic using one or more of psychosocial indicators of books, experts, news and articles, associations, celebrities and pro choices, awards, global computer networks information and blogs, and people's choice to generate respective search results for each of said indicators;
arranging said search results for each of said indicators from most credible to least credible; and
combining said search results of said indicators to form a report that ranks the searched product, service or topic from most preferred to least preferred.

14. The system of claim 13, wherein said step of concurrently searching comprises four layers for each of said indicators, said layers comprising:
activating building blocks, precursors and sources as a first layer to generate first layer results;
inputting said first layer results into a second layer comprising semantic and citation analysis searching to form second layer results;
inputting said second layer results into a third layer that comprises general filtering based on the respective category to form third layer results; and
inputting said third layer results into a fourth layer that comprises special filtering based on the respective category to form fourth layer results.

15. The system of claim 14, the web server further performs the step of generating a report for a respective category.

16. The system of claim 13, wherein said step of combining said search results comprises applying weights to the search results from each of said indicators.

17. The system of claim 14, wherein said special filtering for said indicator of books comprises searching best-selling statistics, date of publication, book reviews, volume in print/sales, merge of top publishers and supplier data.

18. The system of claim 14, wherein said special filtering for said indicator of experts comprises various news sources on specific products, services or topics written by known experts.

19. The system of claim 14, wherein said special filtering for said indicator of news comprises qualitative media indicator data from current demographics, audience education, circulation which determine believability.

20. The system of claim 14, wherein said special filtering for said indicator of associations comprises qualitative association data, longevity, journals, membership demographics and industry standard development.

21. The system of claim 14, wherein said special filtering for said indicator of celebrities and pro choice comprises qualitative celebrity and proc indicator data including industry rank a number of pros using the product or service.

22. The system of claim 14, wherein said special filtering for said indicator of awards comprises manufacturer data, association sites and ranking of said association sites according to their qualitative data.

23. The system of claim 14, wherein said special filtering for said indicator of global computer networks information and blogs comprises qualitative indicators of sources' believability including paid versus unpaid, longevity, volume on subject, and retailer versus manufacturer data.

24. The system of claim 14, wherein said special filtering for said indicator of people's choice comprises real-time and archived data and polled summaries with statistical ranking for quality, design and cost.
